(19) United States
(12) Patent Application Publication
(10) Pub. No.: US 2026/0034453 A1
(43) Pub. Date: Feb. 5, 2026

(54) VIRTUAL ENVIRONMENT SKILL AIMING

(71) Applicant: Tencent Technology (Shenzhen) Company Limited, Shenzhen (CN)

(72) Inventor: Ying DENG, Shenzhen (CN)

(73) Assignee: Tencent Technology (Shenzhen) Company Limited, Shenzhen (CN)

(21) Appl. No.: 19/356,788

(22) Filed: Oct. 13, 2025

Related U.S. Application Data
(63) Continuation of application No. PCT/CN2024/097334, filed on Jun. 4, 2024.

(30) Foreign Application Priority Data
Sep. 18, 2023 (CN) 202311208666.1

(51) Int. Cl. A63F 13/56; A63F 13/2145; A63F 13/533; A63F 13/537; G06F 3/0486; G06F 3/0488

(52) U.S. Cl. CPC A63F 13/56; A63F 13/2145; A63F 13/533; A63F 13/537; G06F 3/0486; G06F 3/0488

(57) ABSTRACT

In an aiming method in a virtual environment, the virtual environment including a virtual character is output for display. A view direction of the virtual character is adjusted based on a first trigger operation performed on a first control element. When a switching condition is satisfied, a release direction of a directional skill of the virtual character is adjusted based on a second trigger operation performed on the first control element. The switching condition is configured to trigger a function of the first control element to be switched. Based on a release operation to release the directional skill, the virtual character is controlled to release the directional skill in the release direction.

### RELATED APPLICATIONS

The present application is a continuation of International Application No. PCT/CN2024/097334, filed on Jun. 4, 2024, which claims priority to Chinese Patent Application No. 202311208666.1, filed on Sep. 18, 2023. The entire disclosures of the prior applications are hereby incorporated by reference.

### FIELD OF THE TECHNOLOGY

This application relates to the field of computer and Internet technologies, including an aiming method in a virtual environment.

### BACKGROUND OF THE DISCLOSURE

To improve richness of game operations, in a game, a user is supported to control a virtual object in a virtual environment to release a directional skill. For example, the virtual object is controlled to release the directional skill in the virtual environment to kill a virtual character controlled by another game player.

In related art, in a process of preparing to release the directional skill, a view direction of the virtual character is adjusted through a turning control, and a release direction of the directional skill is adjusted through a skill control. After it is determined that the release direction of the directional skill aims at a release target of the directional skill, the user controls the virtual character to release the directional skill into the virtual environment.

However, in this solution, operations required to be implemented by the user to improve aiming accuracy are intermittent, and efficiency of releasing the directional skill in the release direction is low.

### SUMMARY

Aspects of this disclosure provide an aiming method in a virtual environment, an aiming apparatus in a virtual environment, and a non-transitory computer-readable storage medium. Examples of technical solutions of this disclosure may be implemented as follows:

An aspect of this disclosure provides an aiming method in a virtual environment. In the method, the virtual environment including a virtual character is output for display. A view direction of the virtual character is adjusted based on a first trigger operation performed on a first control element. When a switching condition is satisfied, a release direction of a directional skill of the virtual character is adjusted based on a second trigger operation performed on the first control element. The switching condition is configured to trigger a function of the first control element to be switched. Based on a release operation to release the directional skill, the virtual character is controlled to release the directional skill in the release direction.

An aspect of this disclosure provides an information processing apparatus. The apparatus includes processing circuitry configured to output for display the virtual environment including a virtual character. The processing circuitry is configured to adjust a view direction of the virtual character based on a first trigger operation performed on a first control element. The processing circuitry is configured to adjust, when a switching condition is satisfied, a release direction of a directional skill of the virtual character based on a second trigger operation performed on the first control element. The switching condition is configured to trigger a function of the first control element to be switched. The processing circuitry is configured to control, based on a release operation to release the directional skill, the virtual character to release the directional skill in the release direction.

An aspect of this disclosure provides an aiming method in a virtual environment. The method is performed by a terminal device and includes: displaying a virtual environment, the virtual environment including a virtual character; adjusting a view direction of the virtual character in response to a first trigger operation on a first control; adjusting, in a case that a switching condition is satisfied, a release direction of a directional skill of the virtual character in response to a second trigger operation on the first control, the switching condition being configured for triggering a function of the first control to be switched; and controlling, in response to an operation of releasing the directional skill, the virtual character to release the directional skill in the release direction.

An aspect of this disclosure provides an aiming apparatus in a virtual environment. The apparatus includes: a display module, configured to display a virtual environment, the virtual environment including a virtual character; an adjustment module, configured to adjust a view direction of the virtual character in response to a first trigger operation on a first control; the adjustment module being further configured to: adjust, in a case that a switching condition is satisfied, a release direction of a directional skill of the virtual character in response to a second trigger operation on the first control, the switching condition being configured for triggering a function of the first control to be switched; and a release module, configured to control, in response to an operation of releasing the directional skill, the virtual character to release the directional skill in the release direction.

An aspect of this disclosure provides a terminal device. The terminal device includes a memory and a processor, the memory having at least one computer instruction stored therein, and the computer instruction being loaded and executed by the processor to implement the above aiming method in the virtual environment.

An aspect of this disclosure provides a non-transitory computer-readable storage medium storing instructions which, when executed by a processor, cause the processor to implement the above aiming methods in the virtual environment.

An aspect of this disclosure provides a computer program product. The computer program product includes a computer instruction, the computer instruction being stored in a computer-readable storage medium, and a processor reading the computer instruction from the computer-readable storage medium and executing the computer instruction, to implement the above aiming methods in the virtual environment.

The technical solutions provided in the aspects of this disclosure can achieve at least the following beneficial effects:

In the solutions provided in the aspects of this disclosure, before the directional skill is prepared to be released, by adjusting the view direction of the virtual character through the skill control, adjusting the release direction of the directional skill through the skill control in a case that the switching condition is triggered, and subsequently releasing the directional skill, a user can complete a consecutive operation through one skill control, thus releasing the directional skill.

In one aspect, compared with use of different controls to respectively complete view adjustment, release direction adjustment, and skill release, this solution, by completing the foregoing three operations through one control, reduces a quantity of controls that need to be displayed on a game interface, reduces a display density of controls, helps simplify an interface layout and reduce a control display load of the terminal device, and reduces a false touch probability.

In another aspect, by integrating a plurality of operations, it is conducive to improving operation smoothness in the process of releasing the directional skill and improving efficiency of releasing the directional skill, to support rapid release of the directional skill at a key moment of a game. In addition, the user does not need to separately adjust the view direction of the virtual character and the release direction of the directional skill of the virtual character through two unrelated operations, which is conducive to simplifying user operations and improving an operation experience of the user.

### BRIEF DESCRIPTION OF THE DRAWINGS

FIG. 1 is a structural block diagram of a computer system according to an aspect of this disclosure.

FIG. 2 is an interface diagram of an aiming method in a virtual environment according to an aspect of this disclosure.

FIG. 3 is an interface diagram of an aiming method in a virtual environment according to an aspect of this disclosure.

FIG. 4 is a flowchart of an aiming method in a virtual environment according to an aspect of this disclosure.

FIG. 5 is an interface diagram of an aiming method in a virtual environment according to an aspect of this disclosure.

FIG. 6 is an interface diagram of an aiming method in a virtual environment according to an aspect of this disclosure.

FIG. 7 is an interface diagram of an aiming method in a virtual environment according to an aspect of this disclosure.

FIG. 8 is a flowchart of an aiming method in a virtual environment according to an aspect of this disclosure.

FIG. 9 is a flowchart of an aiming method in a virtual environment according to an aspect of this disclosure.

FIG. 10 is an interface diagram of an aiming method in a virtual environment according to an aspect of this disclosure.

FIG. 11 is an interface diagram of an aiming method in a virtual environment according to an aspect of this disclosure.

FIG. 12 is an interface diagram of an aiming method in a virtual environment according to an aspect of this disclosure.

FIG. 13 is a flowchart of an aiming method in a virtual environment according to an aspect of this disclosure.

FIG. 14 is an interface diagram of an aiming method in a virtual environment according to an aspect of this disclosure.

FIG. 15 is a flowchart of an aiming method in a virtual environment according to an aspect of this disclosure.

FIG. 16 is a flowchart of an aiming method in a virtual environment according to an aspect of this disclosure.

FIG. 17 is a flowchart of an aiming method in a virtual environment according to an aspect of this disclosure.

FIG. 18 is an interface diagram of an aiming method in a virtual environment according to an aspect of this disclosure.

FIG. 19 is a flowchart of an aiming method in a virtual environment according to an aspect of this disclosure.

FIG. 20 is an interface diagram of an aiming method in a virtual environment according to an aspect of this disclosure.

FIG. 21 is a flowchart of an aiming method in a virtual environment according to an aspect of this disclosure.

FIG. 22 is a schematic diagram of an aiming apparatus in a virtual environment according to an aspect of this disclosure.

FIG. 23 is a structural block diagram of a terminal device according to an aspect of this disclosure.

### DETAILED DESCRIPTION

To make the objectives, technical solutions, and advantages of this disclosure clearer, the following further describes example of implementations of this disclosure in further detail with reference to the accompanying drawings. When the following description involves the accompanying drawings, unless otherwise indicated, the same numerals in different accompanying drawings represent the same or similar elements. Further, the descriptions of the terms are provided as examples and are not intended to limit the scope of the disclosure.

The terms used in this disclosure are for the purpose of describing specific aspects only and are not intended to limit this disclosure. The singular forms of “a” and “the” used in this disclosure and the appended claims are intended to include the plural forms as well, unless the context indicates otherwise. The term “and/or” used herein indicates and includes any or all possible combinations of one or more associated listed items.

First, examples of terms involved in the aspects of this disclosure are briefly introduced.

Virtual environment: It is a three-dimensional virtual environment displayed (or provided) when a client runs on a terminal. The virtual environment may be a simulated environment of a real world, a semi-simulated and semi-fictional environment, or a fictional environment. The virtual environment is any one of a two-dimensional virtual environment, a 2.5-dimensional virtual environment, or a three-dimensional virtual environment, and the aspects of this disclosure do not limit this. The following aspects are described by using an example in which the virtual environment is a three-dimensional virtual environment.

In some aspects, the virtual environment is a battle environment for virtual characters. For example, in Escape games, at least one virtual character engages in a single game battle in a virtual environment. Each virtual character survives in the virtual environment by escaping attacks launched by an enemy and dangers existing in the virtual environment (such as gas circles and swamps). If hit points of a virtual character in the virtual environment decrease to zero, the life of the virtual character in the virtual environment ends. A virtual character that eventually survives is a winner.

Virtual object: It is a movable object in a virtual environment. The movable object may be a virtual person, a virtual animal, an animation person, or the like, such as a person, an animal, a plant, an oil drum, a wall, or a stone that are displayed in a three-dimensional virtual environment. In some aspects, the virtual object is a three-dimensional model created based on a skeletal animation technology. Each virtual object has a shape and size in the three-dimensional virtual environment, and occupies some space in the three-dimensional virtual environment.

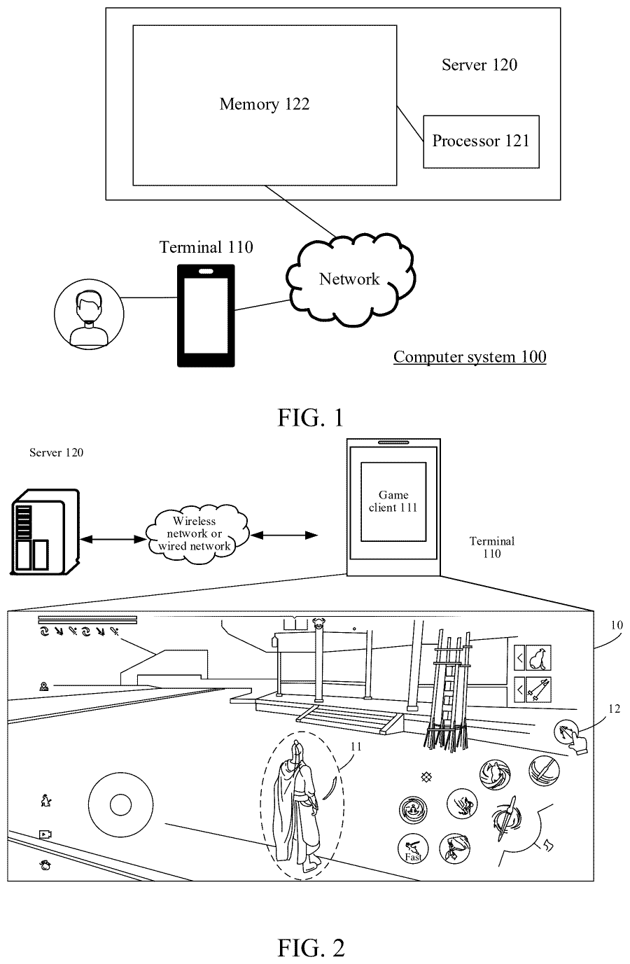

FIG. 1 is a structural block diagram of a computer system 100 according to an aspect of this disclosure. The computer system 100 includes a terminal device 110 and a server 120.

An application program or a web page that supports release of a directional skill of a virtual character in a virtual environment is installed and run on the terminal device 110. The application program that supports release of the directional skill of the virtual character in the virtual environment includes at least one of a game application program, an extended reality (XR) application program, a virtual social application program, an interactive entertainment application program, and a meta-universe application program. The game application program is used as an example for description in this aspect of this disclosure.

In some aspects, a type of the game application includes, but is not limited to, at least one of the following: a shooting game (such as a first person shooting (FPS) game or a third person shooting game), an adventure game (ATG), an action game (ACT), a simulation game (SLG), a multiplayer online battle arena (MOBA) game, and the like.

The terminal device 110 is a terminal device used by a first user. The first user controls, by using the terminal device 110, a first virtual character (a virtual character controlled by the first user) to do activities in a virtual environment. Types of the activities include, but are not limited to, at least one of adjusting a body posture, walking, running, jumping, riding, driving, aiming, picking, and using a throwing prop. For example, the first virtual character is a virtual person, such as a simulated person object or an animation person object. For example, the first user controls, through a control displayed above a virtual environment picture, the first virtual character to do activities in the virtual environment.

For example, as shown in FIG. 2, an example in which a game client 111 that supports release of a directional skill of a virtual character in a virtual environment is installed and run on the terminal device 110 is used. A game interface 10 is displayed on the game client 111. A virtual environment is displayed on the game interface 10, and the virtual environment includes a virtual character 11. The game interface 10 further displays a directional skill control 12. The directional skill control is also referred to as a first control. The directional skill control 12 is configured for triggering the virtual character 11 to release a directional skill. For example, the directional skill is a grabbing skill. The terminal device 110 controls, in response to a trigger operation on the directional skill control 12, the virtual character 11 to release the grabbing skill.

In some aspects, before the directional skill is released, the first user needs to adjust a view direction of the virtual character 11 and a release direction of the directional skill of the virtual character 11, to improve a hit probability of the directional skill. In a case that the view direction of the virtual character 11 and/or the release direction of the directional skill of the virtual character 11 are/is inaccurate, a target effect cannot be achieved by releasing the directional skill. For example, if the directional skill is released to grab an enemy virtual character in a game, in a case that the view direction of the virtual character 11 and/or the release direction of the directional skill are/is not aligned with the enemy virtual character, the enemy virtual character cannot be grabbed.

In this aspect of this disclosure, a user can complete a series of consecutive operations on the directional skill control 12, to adjust both the view direction of the virtual character 11 and the release direction of the directional skill through only one control.

The terminal device 110 is connected to the server 120 through a wireless network or a wired network.

The server 120 includes at least one of one server, a plurality of servers, a cloud computing platform, and a virtualization center. For example, the server 120 includes a processor 121 and a memory 122. The processor 121 is configured to: respond to a requirement of the terminal device 110, and value counting, hit determination, game value settlement, and the like in a game process. The memory 122 is configured to store game data. The server 120 is configured to provide a backend service for a game program that supports release of a directional skill of a virtual character in a virtual environment. In some aspects, the server 120 undertakes main computing work, and the terminal device 110 undertakes secondary computing work. Alternatively, the server 120 undertakes secondary computing work, and the terminal device 110 undertakes main computing work. Alternatively, the server 120 and the terminal device 110 perform computing work in a cooperative manner.

In some aspects, a device type of the terminal device 110 includes at least one of a smartphone, a smart watch, an in-vehicle terminal, a wearable device, a smart television, a tablet computer, an e-book reader, a moving picture experts group audio layer III (MP3) player, a moving picture experts group audio layer IV (MP4) player, a laptop portable computer, and a desktop computer. An example in which the terminal device 110 includes a smartphone is used in the following aspect for illustration.

A person skilled in the art may learn that there may be more or fewer terminal devices 110 described above. For example, there may be only one terminal device 110, or there may be dozens of or hundreds of or more terminal devices 110 described above. A quantity and device type of the terminal device 110 are not limited in this aspect of this disclosure.

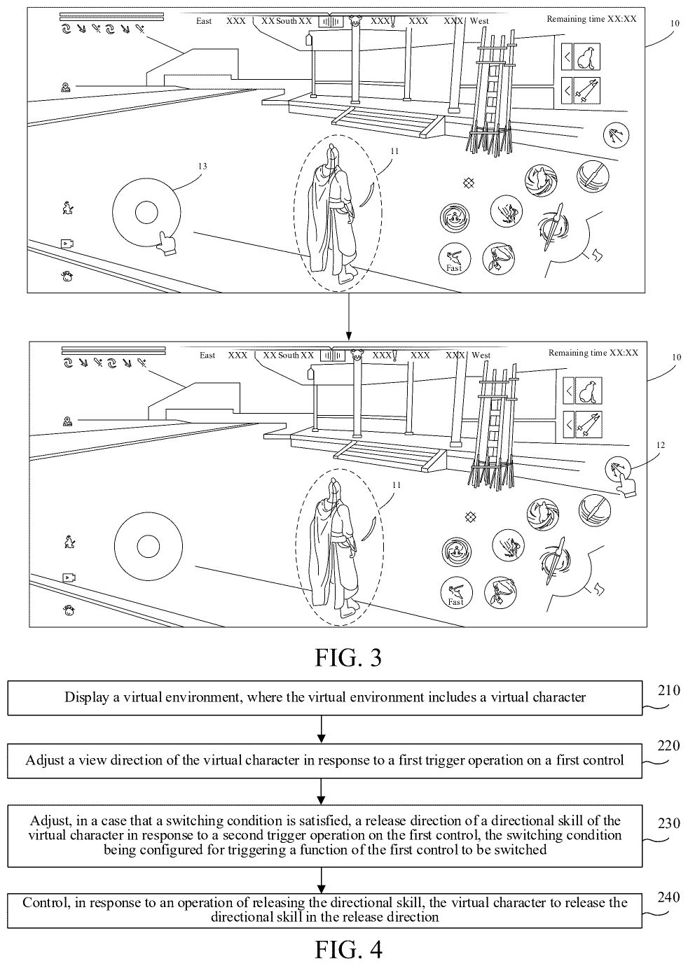

In the related art, adjusting a view direction of a virtual character in a virtual environment and adjusting a release direction of a directional skill of the virtual character are two operations that are independent of each other. The directional skill can hit a release target by adjusting the view direction of the virtual character and the release direction of the directional skill. For example, to successfully release the directional skill, more than one control needs to be used. For example, as shown in FIG. 3, the terminal device adjusts the view direction of the virtual character 11 in response to an adjustment operation on a view adjustment control 13, and then adjusts the release direction of the directional skill of the virtual character 11 in response to an adjustment operation on the directional skill control 12. The adjustment operation on the view adjustment control 13 and the adjustment operation on the directional skill control 12 are two operations that are independent of each other. As shown in FIG. 3, a user completes the adjustment operation on the view adjustment control 13 with the left hand, and completes the adjustment operation on the directional skill control 12 with the right hand. Alternatively, the user first completes the adjustment operation on the view adjustment control 13 with the right hand, then leaves an operation page, and completes the adjustment operation on the directional skill control 12 with the right hand.

In the above solution, the user needs to perform at least two independent operations to release the directional skill of the virtual character. The operations of releasing the directional skill are complex, and there is an interval between different operations, resulting in unsmooth operations of releasing the directional skill, and a poor operation experience.

To solve the above problems, the aspects of this disclosure provide an aiming solution in a virtual environment. In this solution, a view of the virtual character and the release direction of the directional skill are adjusted through one control, so that when the user needs to release the directional skill of the virtual character in a target direction, the user can release the directional skill through one consecutive operation, instead of different operations.

FIG. 4 is a flowchart of an aiming method in a virtual environment according to an aspect of this disclosure. An example in which the method is performed by the terminal device 110 shown in FIG. 1 is used. The terminal device is also referred to as a computer device. The method includes the following operations:

Operation 210: Display a virtual environment, the virtual environment including a virtual character. For example, the virtual environment including a virtual character is output for display.

In some aspects, the terminal device displays a game interface. The game interface is configured for presenting an activity of the virtual character in the virtual environment to a user. In some aspects, the game interface is configured for displaying a virtual environment picture, and the virtual environment picture is related to a view direction of the virtual character. For example, the virtual environment picture is a picture observed in a virtual environment from a first person view of the virtual character. In this case, the virtual character is not displayed in the virtual environment picture. For example, the virtual environment picture is a picture observed in a virtual environment from a third person view of the virtual character. In this case, the virtual character is displayed in the virtual environment picture.

In some aspects, the virtual environment includes the virtual character, and the virtual character moves in the virtual environment under control of a user. In some aspects, the virtual character included in the virtual environment includes, but is not limited to, at least one of the following: a virtual character controlled by a first user and a virtual character controlled by another user. For example, before a game starts, a terminal device determines, in response to a virtual character selection operation, a virtual character controlled by a user in the game. Virtual characters respectively controlled by different users are the same, or different users respectively control different virtual characters. In this aspect of this disclosure, an example in which a virtual environment includes a virtual character 1 controlled by the first user and a virtual character 2 controlled by a second user is used for illustration.

In some aspects, a figure of the virtual character 1 and a figure of the virtual character 2 are the same. For example, the figure of the virtual character 1 and the figure of the virtual character 2 are the same cartoon characters. In some aspects, a figure of the virtual character 1 and a figure of the virtual character 2 are different. For example, the figure of the virtual character 1 is a cartoon character, and the figure of the virtual character 2 is an animation character.

In some aspects, a first control is displayed on the game interface. The first control is configured for triggering the virtual character to release a directional skill. In some aspects, the first control has any display form. For example, the display form of the first control includes, but is not limited to, another form such as a round form and a square form. The display form of the first control is determined according to an actual need, and is not limited herein. In this aspect of this disclosure, the first control is also referred to as a directional skill control.

In some aspects, the directional skill is a character skill shot in a release direction. For example, the directional skill is configured for being released in the release direction. In some aspects, the directional skill includes a hook lock skill. The hook lock skill is configured for launching a hook lock in the release direction. After a target is hit, the target is hooked within an attack range of the virtual character. The target includes, but is not limited to, a virtual prop, another virtual character (an enemy virtual character or an friend virtual character) in the virtual environment, and the like.

For example, after the virtual character controlled by the user releases the hook lock skill into the virtual environment, if the enemy virtual character is within a sensing range of the hook lock skill, it is determined that a hook lock skill control hits the enemy virtual character. Subsequently, the hook lock skill hooks the enemy virtual character to be in front of the virtual character controlled by the first user, to shorten a distance between the virtual character controlled by the first user and the enemy virtual character.

In an example, the first control is a release control of the directional skill. For example, in this solution provided in this disclosure, an original release control of the directional skill in the game interface is reused. In an example, the terminal device switches, in response to a function switching operation, a function of the first control to adjust both the view direction of the virtual character and the release direction of the directional skill. If the terminal device does not make a response to the function switching operation, the first control is only configured for adjusting the release direction of the directional skill. The function switching operation is configured for changing the function of the first control. Reference can be made to the following aspects for an example of the function switching operation.

In this manner, simplicity of the operation of releasing the directional skill is improved, and a new control does not need to be added on the game interface, which is conducive to reducing a display density of a plurality of controls and reducing a false touch probability caused by a dense control distribution.

For example, the first control is newly added to implement the function provided in this solution of this disclosure. For example, the first control is displayed at a position that does not overlap another control on the game interface.

Operation 220: Adjust a view direction of the virtual character in response to a first trigger operation on a first control. For example, a view direction of the virtual character is adjusted based on a first trigger operation performed on a first control element.

In some aspects, the first trigger operation is configured for adjusting the view direction of the virtual character.

In some aspects, the first trigger operation includes at least one of single click/tap, double click/tap, slide left and right, slide up and down, touch and hold, hover, face recognition, and voice recognition. The first trigger operation includes, but is not limited to, the above several types, and is not limited herein.

In some aspects, the first trigger operation is a drag operation performed on the first control, and is also referred to as a first drag operation. In some aspects, the first trigger operation includes a clicking/tapping operation and a moving operation. For example, that the terminal device detects the first trigger operation includes: detecting the clicking/tapping operation in a sensing region of the first control and that a contact point generated by the clicking/tapping operation moves in the sensing region of the first control. The contact point is a contact position between a finger of a user and the terminal device. For example, the first trigger operation is an operation of causing the contact point to move a distance after the operation starts. The sensing region of the first control is an effect-taking region of the first control. The terminal device associates the operation of detection in the sensing region of the first control with a function of the first control, to control the release process of the directional skill through the first control.

For example, the first control and a drag identifier of the first control are displayed on the game interface. In response to the first drag operation on the first control, the terminal device changes a display position of the drag identifier on the game interface. For example, if the first trigger operation is a rightward movement drag operation, the drag identifier moves to the right along with the first trigger operation. For example, the drag identifier is displayed in a virtual joystick style.

In some aspects, the first trigger operation takes effect in a target region. The target region is an effect-taking region of the first trigger operation. For example, the first trigger operation is valid in the target region. The first trigger operation is invalid after going beyond the target region, and the view direction of the virtual character does not continue to change. For example, the target region is included in the sensing region of the first control. For example, the target region is a right half region of the sensing region of the first control. For example, the target region includes the sensing region of the first control.

In some aspects, the drag operation on the first control includes a clockwise drag operation on the first control and an anticlockwise drag operation on the first control. The clockwise drag operation on a first wheel is configured for adjusting the view direction of the virtual character in a clockwise direction, and the anticlockwise drag operation on the first wheel is configured for adjusting the view direction of the virtual character in the anticlockwise direction.

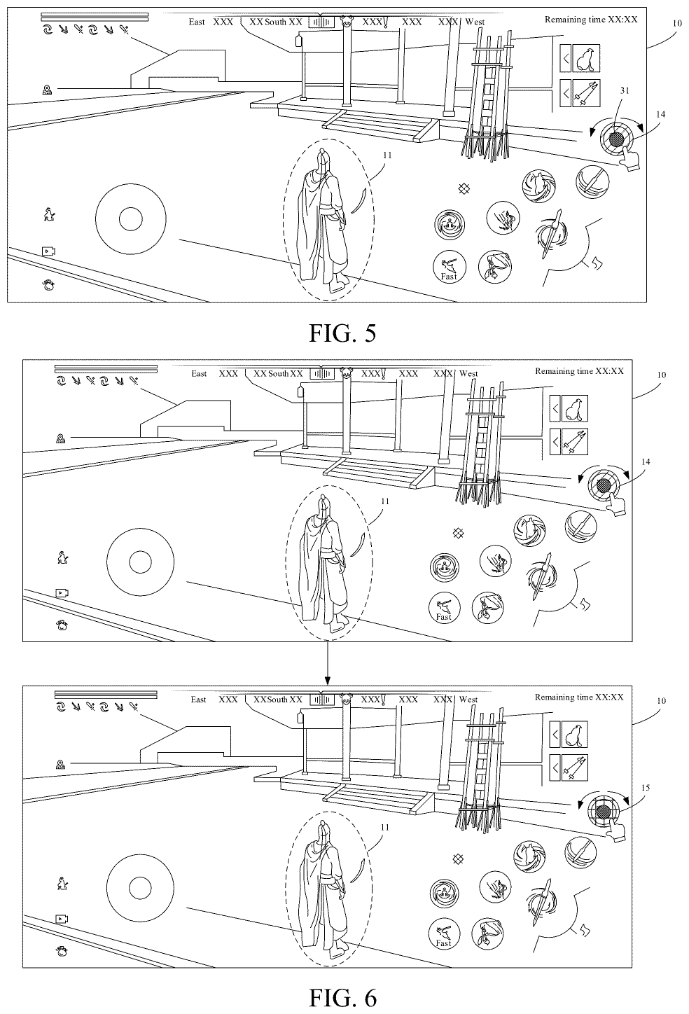

For example, as shown in FIG. 5, the view direction of the virtual character 11 is adjusted in the clockwise direction in response to the clockwise drag operation on a first wheel 14. The view direction of the virtual character 11 is adjusted in the anticlockwise direction in response to the anticlockwise drag operation on the first wheel 14.

In some aspects, the first control includes a first virtual joystick for adjusting the view direction of the virtual character. For example, as shown in FIG. 5, the view direction of the virtual character 11 is adjusted in response to the drag operation on a first virtual joystick 31.

In some aspects, the view direction of the virtual character is configured for representing a field of view range of the virtual character in the virtual environment. In some aspects, the view direction of the virtual character is a view direction of a virtual camera corresponding to the virtual character. The virtual camera corresponding to the virtual character follows the virtual character to move in the virtual environment, and acquires a virtual environment picture from the virtual environment based on a three-dimensional imaging principle. For example, adjusting the view direction of the virtual character is the same as adjusting the view direction of the virtual camera.

For example, a position relationship between the virtual camera and the top of the head of the virtual character (or a shoulder of the virtual character) is kept relatively still, so that the acquired virtual environment picture can simulate the first person view of the virtual character. For example, a relative position between the virtual camera and the virtual character remains unchanged. The virtual camera rotates around a rotation center of the virtual camera, to adjust a view of the virtual character.

For example, the virtual camera is kept at a first distance from the virtual character, so that the acquired virtual environment picture can simulate the third person view and reflect the virtual environment around the virtual character. The first distance is set in advance, or the first distance can change in response to a distance adjustment operation.

In some aspects, the first control is configured for adjusting the view direction of the virtual character by the first user. In this aspect of this disclosure, the view of the virtual character is the first person view, and the first person view can be adjusted in any direction. For example, the view direction of the virtual character supports 360-degree rotatable adjustment, so as to simulate a pitch view, a left-right deflection view, and a front-back deflection view of the virtual character in the virtual environment.

Operation 230: Adjust, in a case that a switching condition is satisfied, a release direction of a directional skill of the virtual character in response to a second trigger operation on the first control, the switching condition being configured for triggering a function of the first control to be switched. For example, when a switching condition is satisfied, a release direction of a directional skill of the virtual character is adjusted based on a second trigger operation performed on the first control element. The switching condition is configured to trigger a function of the first control element to be switched.

In some aspects, the function of the first control includes at least one of the following: adjusting the view direction of the virtual character and adjusting the release direction of the directional skill. In some aspects, the switching condition is configured for switching the function of the first control from adjusting the view direction of the virtual character to adjusting the release direction of the directional skill. For example, in a case that a trigger condition of the directional skill is not satisfied, the first control is configured for adjusting the view direction of the virtual character. In a case that the trigger condition of the directional skill is satisfied, the first control is configured for adjusting release direction of the directional skill.

In some aspects, the switching condition is a preset fixed condition. In some aspects, the switching condition is an adjustable condition. For example, the switching condition is a condition adjusted by a user in an actual operation process.

For example, the switching condition includes one of the following:
a function switching operation on the first control is received; and
the first trigger operation stops.

For examples of specific content of the function switching operation, reference can be made to the following aspects.

In some aspects, the switching condition is triggered by an operation of a user. The user adjusts the view direction of the virtual character through the first trigger operation on the first control. After determining that the view direction of the virtual character faces an enemy display element, the user performs a corresponding user operation (such as implementing the function switching operation), so that after detecting the function switching operation, the terminal device determines to trigger the switching condition, and the terminal device switches the function of the first control. For example, that the first trigger operation stops refers to that a contact point corresponding to the first trigger operation does not move within a period of time, or the contact point corresponding to the first trigger operation is located in a target region in a first wheel. The period of time may be set in advance, for example, 0.5 seconds. The target region is set in advance. For example, the target region is a circular region at a center of the first control. A display style of the target region is different from a display style of another region of the first control, to facilitate the user in distinguishing a distribution position of the target region in the first control.

In some aspects, an enemy is a virtual character controlled by another user in the virtual environment except the virtual character 1 controlled by the first user. For example, the enemy is another virtual character that is in a confrontation state with the virtual character 1 controlled by the first user in the virtual environment, such as the virtual character 2 controlled by the second user. The enemy display element is a display element for representing an enemy, for example, a sound element. For example, the sound element is also referred to as a voiceprint. In a process that the enemy virtual character moves in the virtual environment, a sound may be generated, and the sound element is configured for indicating a relative direction between a source of the sound and the virtual character.

In some aspects, a display position of the enemy display element is fixed. For example, after the enemy virtual character moves in the virtual environment for one second, the enemy display element is configured for indicating an orientation of the enemy virtual character before the enemy virtual character moves. In some aspects, the display position of the enemy display element changes as the position of the enemy virtual character changes. For example, the position of the enemy display element changes in real time as the enemy virtual character moves.

In some aspects, in a case that a user adjusts the view direction of the virtual character to face a display region in which the enemy display element is located, the user determines that the view direction of the virtual character faces the enemy display element, and subsequently, the user performs the function switching operation, to switch the function of the first control. In some aspects, the display region is a region having a fixed size and a fixed shape. For example, the display region is a fan-shaped display region based on the enemy display element.

In some aspects, the terminal device switches a display form of the first control in a case that the switching condition is satisfied. For example, when the function of the first control is to adjust the view direction of the virtual character, the first control is displayed as a first wheel. When the function of the first control is to adjust the release direction of the directional skill, the first control is displayed as a second wheel. The first wheel is configured for adjusting the view direction of the virtual character, and the second wheel is configured for adjusting the release direction of the directional skill.

In some aspects, in a case that the first trigger operation does not end and the switching condition is satisfied, the terminal device cancels displaying the first wheel, and displays the second wheel in a display region of the first wheel. For example, the first wheel is displayed as the second wheel in a case that the switching condition is satisfied. In some aspects, that the first wheel is switched to be displayed as the second wheel includes: keeping displaying the first wheel, and displaying the second wheel in the display region of the first wheel. The second wheel covers the first wheel.

For example, as shown in FIG. 6, in a case that the switching condition is satisfied, the terminal device switches to display the first wheel 14 as a second wheel 15. For example, display styles of the first wheel and the second wheel are different, so as to remind, based on the display styles, a user that the function of the first control has been switched. For examples of the display styles of the first wheel and the second wheel, reference can be made to the following aspects.

In some aspects, the second trigger operation includes at least one of single click/tap, double click/tap, slide left and right, slide up and down, touch and hold, hover, face recognition, and voice recognition. The second trigger operation includes, but is not limited to, the above several types, and is not limited herein. In some aspects, the second trigger operation is implemented as a drag operation on the first control, and is also referred to as a second drag operation. For example, the first drag operation and the second drag operation are drag operations of the same type.

For example, duration in which the first control receives the drag operation is [0, T]. At time t, the function of the first control is switched from adjusting the view direction of the virtual character to adjusting the release direction of the directional skill. In this case, the drag operation within [0, t] belongs to the first drag operation, and a drag operation within (t, T] belongs to the second drag operation, where t is a positive number less than or equal to T. For example, the second drag operation and the first drag operation are the same drag operation.

For example, in a case that the first control is displayed from the first wheel into the second wheel, the second drag operation is a drag operation that continues from the first wheel to the second wheel.

In some aspects, the second drag operation includes a clockwise drag operation on the first control and an anticlockwise drag operation on the first control. The clockwise drag operation is configured for adjusting the release direction of the directional skill in a clockwise direction, and the anticlockwise drag operation is configured for adjusting the release direction of the directional skill in an anticlockwise direction.

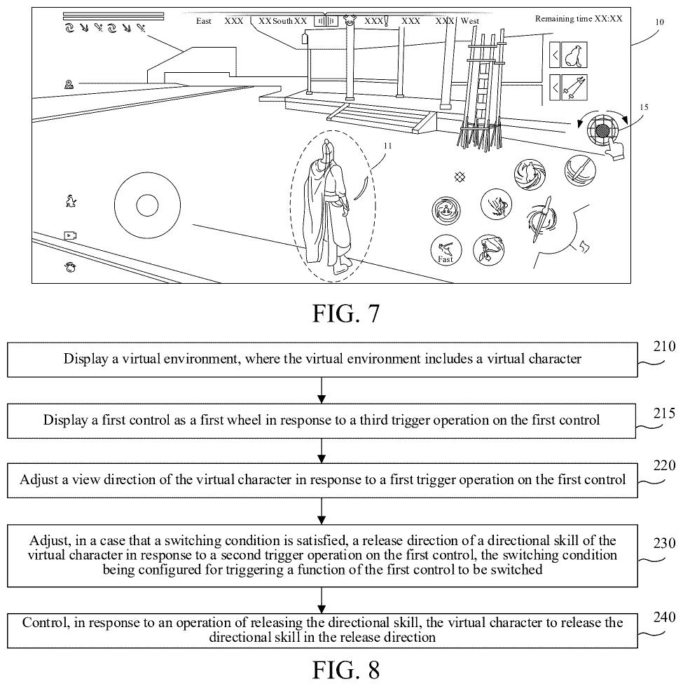

For example, as shown in FIG. 7, in response to the clockwise drag operation on the first control (which is displayed in the form of the second wheel. For an example of the second wheel, reference can be made to the following description), the release direction of the directional skill of the virtual character 11 is adjusted in the clockwise direction. In response to the anticlockwise drag operation on the first control, the release direction of the directional skill of the virtual character 11 is adjusted in the anticlockwise direction.

In some aspects, after function switching occurs, the first control is displayed as the second wheel, and the second wheel includes a second virtual joystick for adjusting the view direction of the virtual character. The terminal device adjusts the release direction of the directional skill of the virtual character in response to a drag operation on the second virtual joystick, so that a user can, through the second trigger operation, adjust the release direction of the directional skill to a direction of the enemy virtual character.

In an example, the second trigger operation is similar to the first trigger operation. For examples of the second trigger operation, reference can be made to the description of the first trigger operation. Details are not elaborated herein again.

Operation 240: Control, in response to an operation of releasing the directional skill, the virtual character to release the directional skill in the release direction. For example, based on a release operation to release the directional skill, the virtual character is controlled to release the directional skill in the release direction.

In some aspects, the release direction of the directional skill is a direction obtained by adjustment through the second trigger operation. For example, the release direction of the directional skill is a direction to which the directional skill points in the virtual environment when the second trigger operation ends.

In some aspects, the operation of releasing the directional skill includes at least one of single click/tap, double click/tap, slide left and right, slide up and down, touch and hold, hover, face recognition, and voice recognition. The release operation of releasing the directional skill includes, but is not limited to, the above several types, and is not limited herein.

In some aspects, the operation of releasing the directional skill is performed on the first control. In some aspects, the operation of releasing the directional skill is related to the second trigger operation. For example, the operation of releasing the directional skill is that the second trigger operation disappears. For example, the terminal device adjusts the release direction of the directional skill in response to the second trigger operation on the first control, and controls, in response to the second trigger operation disappearing, the virtual character to release the directional skill in the release direction. The disappearance of the second trigger operation is implemented by detecting, by the terminal device, that a contact point of the second trigger operation disappears.

Certainly, an operation of releasing the directional skill may alternatively be performed on a third control except the first control. In some aspects, the operation of releasing the directional skill is a trigger operation on the third control. For example, the terminal device controls, in response to a clicking/tapping operation on the third control, the virtual character to release the directional skill in the release direction.

The first trigger operation, the second trigger operation, and the operation of releasing the directional skill form an entire consecutive operation. For example, in this solution provided in this disclosure, releasing the directional skill needs to be implemented by the first user by consecutively completing the above operations within a first time period. For example, the first user consecutively performs, on the game interface, the first trigger operation, the second trigger operation, and the operation of releasing the directional skill with the right hand. Since the above three operations are all implemented on the first control, by setting a plurality of operation types on the first control, the operations of adjusting the view direction of the virtual character, adjusting the release direction of the directional skill, and releasing the directional skill can be instantly completed.

In an example, the directional skill is a hook lock skill. The terminal device displays the virtual environment and the enemy display element of the enemy virtual character on the game interface. The terminal device adjusts the view direction of the virtual character in response to the first trigger operation on the first control. A user aligns the view direction of the virtual character to the enemy display element through the first trigger operation. Subsequently, the user performs the function switching operation, to control the function of the first control to be switched to adjusting the release direction of the hook lock skill. The terminal device adjusts the release direction of the hook lock skill in response to the second trigger operation on the first control. After the user determines that the release direction of the hook lock skill is aligned with the enemy virtual character, the operation of releasing the hook lock skill is performed. The terminal device controls, in response to the operation of releasing the hook lock skill, the virtual character to release the hook lock skill in the release direction.

In some aspects, the terminal device displays, on the game interface, that a hook lock corresponding to the hook lock skill moves in the release direction in the virtual environment. In the moving process of the hook lock, if there is an enemy virtual character within a sensing range of the hook lock, the terminal device displays a display effect that the hook lock passively moves the enemy virtual character to be in front of the virtual character. If there is no enemy virtual character within the sensing range of the hook lock, the hook lock continues to move in the release direction in the virtual environment until a distance between the hook lock and the virtual character is equal to a launching threshold of the hook lock. For example, the launching threshold is determined in advance.

In conclusion, before the directional skill is prepared to be released, by adjusting the view direction of the virtual character through the skill control, adjusting the release direction of the directional skill through the skill control in a case that the switching condition is triggered, and subsequently releasing the directional skill, a user can complete a consecutive operation through one skill control, thus releasing the directional skill.

In one aspect, compared with use of different controls to respectively complete view adjustment, release direction adjustment, and skill release, this solution, by completing the foregoing three operations through one control, reduces a quantity of controls that need to be displayed on a game interface, reduces a display density of controls, simplifies an interface layout, and reduces a false touch probability.

In another aspect, by integrating a plurality of operations, it is conducive to improving operation smoothness in the process of releasing the directional skill and improving efficiency of releasing the directional skill, to support rapid release of the directional skill at a key moment of a game. It helps the user to win in the game, and it is conducive to shortening duration of a game battle.

Changes in a display effect before and after the function of the first control is switched are described below through several aspects.

In some aspects, the method further includes: switching, in a case that the switching condition is satisfied, to display the first control, which is displayed as a first wheel, as a second wheel, the first wheel and the second wheel having different display styles.

In some aspects, the first wheel and the second wheel are two different display forms of the first control. In a case that the function of the first control is changed, the terminal device may perform displaying switching between the first wheel and the second wheel. In some aspects, when the function of the first control is to adjust the view direction of the virtual character, the display form of the first control is the first wheel. When the function of the first control is to adjust the release direction of the directional skill, the display form of the first control is the second wheel.

For example, the first wheel is an original display style of the first control. For example, after a user enters a game, the first control is displayed as the first wheel on a game interface. For example, after the first control is triggered, the terminal device switches to display the first control from the original display style to the first wheel.

In some aspects, a display position of the first wheel and a display position of the second wheel on the game interface are the same. After the switching condition is satisfied, the terminal device displays the second wheel to replace the displaying of the first wheel.

Since the display position of the first wheel and the display position of the second wheel on the game interface are the same, and the display style of the first wheel and the display style of the second wheel are different, after the function of the first control is switched, a change in a visual effect of the first control can remind a user to adjust the release direction of the directional skill through the first control. For example, the first control and the second control do not need to be simultaneously displayed on the game interface, thereby reducing a requirement for redesigning arrangement of controls on the game interface, which is conducive to reducing a workload brought to developers due to the implementation of this solution in the game.

In some aspects, each display style includes at least one of the following: a color, a size, and a shape.

For example, the first wheel and the second wheel are different in at least one of the color, the size, and the shape.

The color refers to a display color of the first wheel (or the second wheel) on the game interface. The size is configured for representing a display region occupied by the first wheel (or the second wheel) on the game interface. The shape is configured for representing a boundary appearance of the first wheel (or the second wheel).

In some aspects, the first wheel and the second wheel have any shapes. For example, the shape of the first wheel is a circle, a square, or in another form. In some aspects, the shapes of the first wheel and the second wheel are the same. For example, the first wheel and the second wheel are both circular wheels with the same size. In some aspects, the shapes of the first wheel and the second wheel are different. For example, the first wheel is a circular wheel corresponding to size 1, and the second wheel is a circular wheel corresponding to size 2.

In some aspects, center points of the first wheel and the second wheel are the same. For example, the center point of the first wheel is located at a first coordinate point on the game interface, and a center point of the second wheel is also located at the first coordinate point on the game interface. For example, in a case that the center points of the first wheel and the second wheel are the same, other display forms of the first wheel and the second wheel may be different or the same. For example, in a case that the center points of the first wheel and the second wheel are the same, a display area of the second wheel is larger than a display area of the first wheel. Alternatively, a display color of the first wheel is a first color, and a display color of the second wheel is a second color. In a case that the center points of the first wheel and the second wheel are the same, other display conditions of the first wheel and the second wheel are different, so that when the first user performs an operation on the first wheel, it can be avoided that switching between the first wheel and the second wheel is not observed in time due to blocking by a finger. In some aspects, a position of the first virtual joystick on the first wheel and a position of the second virtual joystick on the second wheel are the same.

In some aspects, center points of the first wheel and the second wheel are different. For example, the center point of the first wheel is located at a first coordinate point on the game interface, and the center point of the second wheel is located at a second coordinate point on the game interface. In some aspects, the center point of the second wheel is determined based on a drag position at a displaying switching moment, and the displaying switching moment is a moment at which the displaying of the first wheel is switched to the displaying of the second wheel. For example, the first user performs a drag operation on the first wheel, and determines, when the first wheel is moved to a target drag position, that the view direction of the virtual character faces the enemy display element. In this case, the displaying of the first wheel is switched to the displaying of the second wheel, and the target drag position is used as the center point of the second wheel. In some aspects, a position of the first virtual joystick on the first wheel and a position of the second virtual joystick on the second wheel are different.

In some aspects, when the center points of the first wheel and the second wheel are different, coupling of operation responses on the first wheel and the second wheel, which is caused when the drag operation on the first wheel and the drag operation on the second wheel are a consecutive operation, can be avoided. For example, when the center points of the first wheel and the second wheel are the same, the first user performs the drag operation on the first wheel, and determines, when the first wheel is moved to the target drag position, that the view direction of the virtual character faces the enemy display element. In this case, the displaying of the first wheel is switched to the displaying of the second wheel. In this case, the terminal device may make an incorrect response to a finger position of the first user being at the target drag position, causing incorrect adjustment on the release direction of the directional skill of the virtual character and further requiring a user to spend more time in adjustment.

In this aspect of this disclosure, an example in which the first wheel is a circular wheel filled with oblique lines and the second wheel is a circular wheel filled with cross lines is used for description.

By setting that the two wheels are different in at least one of the color, the size, and the shape, a workload of switching the displaying of the two wheels is reduced while providing a function switching prompt to a user. When the first wheel is switched to the second wheel, the terminal device only needs to change the display style of the wheel, and display positions of controls do not need to be laid out on the game interface again, which is conducive to reducing a display load of the terminal device.

The function of the first control for adjusting the view direction of the virtual character needs to be activated. Operations required to be performed for activating the function of adjusting the view direction of the virtual character are described below through several aspects.

In some aspects, as shown in FIG. 8, before operation 220, the method further includes: operation 215: Display the first control as the first wheel in response to a third trigger operation on the first control. For example, the first control element is output for display as the first wheel based on a third trigger operation performed on the first control element.

In some aspects, the first control is a skill control in a game. For example, an original control in the game is reused in this solution. In some aspects, before the third trigger operation is received, the function of the first control is to adjust the release direction of the directional skill. The function of the first control for adjusting the view direction of the virtual character is activated through the third trigger operation.

In some aspects, the third trigger operation on the first control includes at least one of single click/tap, double click/tap, slide left and right, slide up and down, touch and hold, hover, face recognition, and voice recognition. The trigger operation on the directional skill control includes, but is not limited to, the above several types, and is not limited herein. For example, the third trigger operation on the first control is an operation of clicking/tapping the first control. For example, the third trigger operation on the first control is a slide operation of sliding from another region on the game interface to the sensing region of the first control. For an example of the another region, reference can be made to the following aspects.

In some aspects, displaying the first control as the first wheel refers to displaying the first control in a style of the first wheel. For example, the terminal device switches the first control from an original display style to the display style of the first wheel in response to the third trigger operation on the first control. The original display style of the first control is different from the display style of the first wheel. For example, the first control is gray, and the first wheel is yellow.

In some aspects, the displaying the first control as the first wheel in response to a third trigger operation on the first control includes: keeping displaying the first control in response to the trigger operation on the first control, and displaying the first wheel above the first control. For example, the first wheel covers the directional skill control.

In some aspects, the first trigger operation in the above aspect is a trigger operation performed on the first wheel. For example, after the terminal device makes a response to the third trigger operation on the first control, the first control is displayed in the style of the first wheel. The terminal device adjusts the view direction of the virtual character in response to the first trigger operation on the first wheel.

In this aspect, the function of the first control for adjusting the view direction of the virtual character is activated through the third trigger operation on the first control, so that the first control is switched to different functions when different operations are received, which enriches a function type that can be completed through the first control and is conducive to completing, through one control, all the operations required in the process of releasing the directional skill, thereby controlling a quantity of controls that need to be displayed on the game interface. When a new combined function is implemented, no extra control is introduced to the game interface, thereby improving display simplicity of the game interface.

An implementation of the third trigger operation is described below through several aspects.

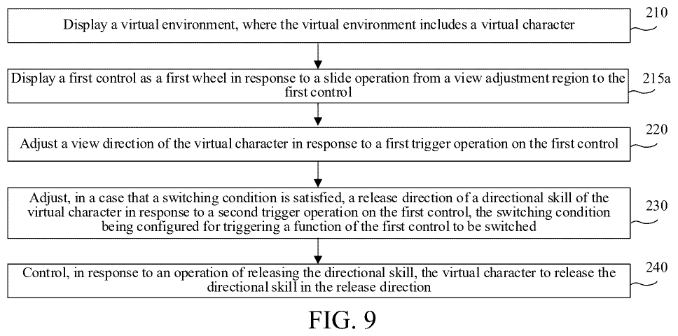

In some aspects, as shown in FIG. 9, operation 215 is implemented as: sub-operation 215a: Display the first control as the first wheel in response to a slide operation from a view adjustment region to the first control. For example, the first control element is output for display as the first wheel based on a sliding operation performed from a view adjustment region to the first control element.

In some aspects, a start point of the slide operation is located inside the view adjustment region or at a boundary of the view adjustment region, and an end point of the slide operation is located inside the sensing region of the first control. In some aspects, the slide operation and the first trigger operation in the above aspect are consecutive operations. For example, the slide operation and the first trigger operation share the same contact point. For example, after the contact point of the slide operation reaches the sensing region of the first control, a position change of the contact point depends on the first trigger operation.

In some aspects, the view adjustment region is a partial region on the game interface. For example, the view adjustment region is a rectangular region on the game interface. A center of the view adjustment region overlaps a center of the game interface. For example, the view adjustment region is configured for adjusting the view direction of the virtual character.

In some aspects, the view adjustment region is any region that does not affect a game display element on the game interface. The game display element includes at least one of a virtual character, a virtual prop, and a control. For example, the view adjustment region is a blank region on the game interface, or a region that does not affect responses of other controls on the game interface.

In some aspects, the view adjustment region is a preset fixed region. In some aspects, a position of the view adjustment region on the game interface is determined based on the virtual character. For example, the view adjustment region is determined based on the view direction of the virtual character. For example, the view adjustment region is a region that uses the view direction of the virtual character as a center and has a fixed size. In a case that the virtual environment is displayed at the first person view of the virtual character in the game, the view adjustment region is located at the center of the game interface.

For example, the view adjustment region is determined based on a position of the virtual character in the virtual environment. For example, the view adjustment region is displayed above the virtual character. After the virtual character moves in the virtual environment, a position of the virtual character in the virtual environment picture changes, and the position of the view adjustment region on the game interface also changes, to keep the view adjustment region above the virtual character.

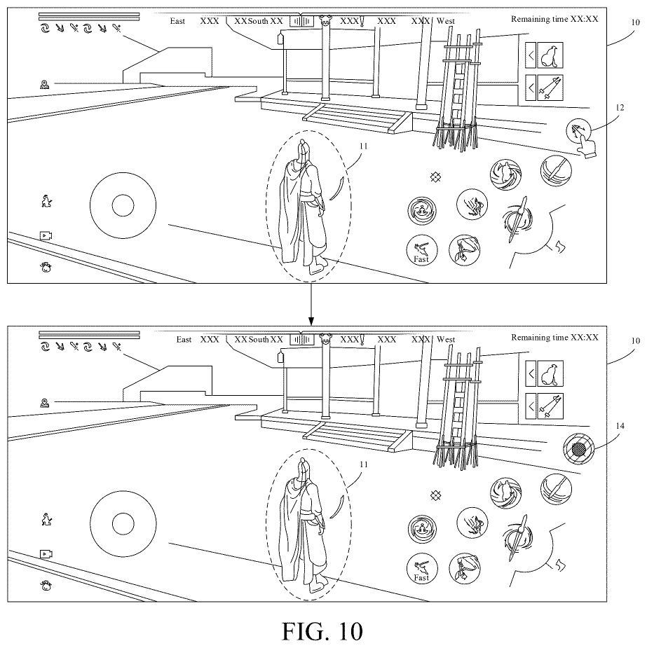

For example, as shown in FIG. 10, the terminal device displays the first wheel 14 on a first control 12 in response to the third trigger operation on the first control 12.

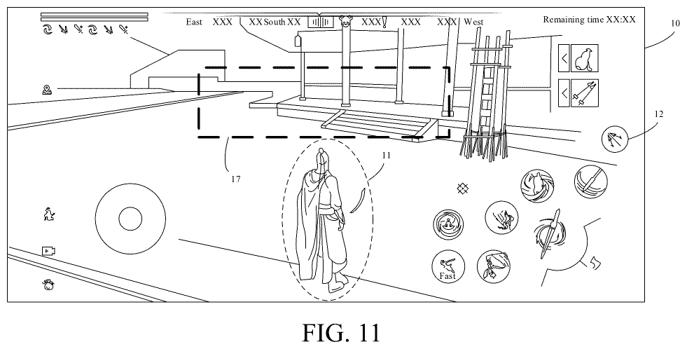

In some aspects, in a game process, the view adjustment region belongs to a fixed region. The fixed region is a region having a fixed form and a fixed size. For example, as shown in FIG. 11, the view adjustment region is a first region 17 that changes as the position of the virtual character 11 changes.

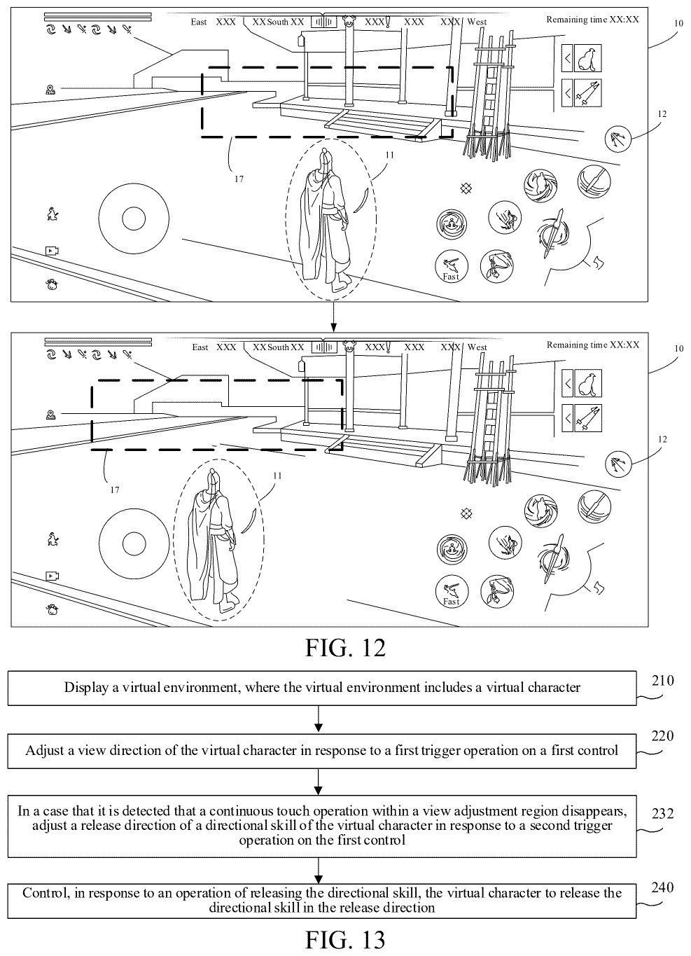

In some aspects, the position of the view adjustment region is fixed. In some aspects, the position of the view adjustment region is randomly adjusted. In some aspects, the position of the view adjustment region is adjusted based on the view direction of the virtual character. In some aspects, the position of the view adjustment region is adjusted based on a movement position of the virtual character. For example, as shown in FIG. 12, when the virtual character 11 moves from a first position to a second position, the first region 17 moves from a first adjustment position to a second adjustment position.

In some aspects, the first control is any skill control displayed on the game interface. For example, the virtual character controlled by the first user has two directional skills, and skill controls respectively corresponding to the two directional skills are displayed on the game interface, and the first control is any one of the above two skill controls. In some aspects, the first control is a skill control to which the slide operation is performed to slide. For example, a skill control 1 and a skill control 2 are displayed on the game interface. The slide operation slides from the view adjustment region to the skill control 2, and the first control is the skill control 2. For example, a slide operation from the view adjustment region to the outside is set, which can activate the function of adjusting the view direction of the at least one skill control.

By setting the slide operation from the view adjustment region to the skill control to activate a view adjustment function of the skill control (namely, adjusting the view direction of the virtual character), the operations related to releasing the directional skill can be intensively completed on the skill control, thereby improving the efficiency of releasing the directional skill.

In addition, setting the slide operation from the view adjustment region to the skill control helps to improve flexibility of selecting the skill control. Since an end position of the slide operation starting from the view adjustment region may be autonomously selected by a user, in a case that a plurality of skill controls are displayed on the game interface, a slide operation from the view adjustment region to a target skill control (i.e. the first control) among the plurality of skill controls is supported to activate the view adjustment function of the target skill control. In this manner, without introducing other controls, the view adjustment functions of the plurality of skill controls have a chance to be activated, which helps to improve universality in a directional skill aiming process.

The operation process of displaying the first control as the first wheel is described below through several aspects.

In some aspects, sub-operation 215a of displaying the first control as the first wheel in response to a slide operation from a view adjustment region to the first control includes: the terminal device displays the first control as the first wheel in response to a continuous touch operation having been monitored within the view adjustment region and the slide operation from the view adjustment region to the first control.

In some aspects, the continuous touch operation refers to an operation in which a contact point exists for a period of time. For example, after a user touches the terminal device with a finger, the finger keeps not leaving the terminal device for a period of time. In some aspects, the continuous touch operation includes at least one of double click/tap, slide left and right, slide up and down, and touch and hold. The continuous touch operation includes, but is not limited to, the above several types, and is not limited here in this disclosure.

In some aspects, the continuous touch operation is performed at any position within the view adjustment region. In some aspects, a trigger control is configured in the view adjustment region. For example, a sensing region of the trigger control overlaps the view adjustment region, or the sensing region of the trigger control is located within the view adjustment region. The continuous touch operation is a continuous operation on a trigger control. In some aspects, that the continuous touch operation has been monitored within the view adjustment region includes: the continuous touch operation on the touch control has been monitored within the view adjustment region.

In some aspects, the sensing region of the first control is adjacent to the view adjustment region. For example, there is a common side or an overlapping region between the sensing region of the first control and the view adjustment region. In some aspects, a space is reserved between the sensing region of the first control and the view adjustment region. For example, the sensing region of the first control is not adjacent to the view adjustment region. In the sliding process, the slide operation from the view adjustment region to the first control needs to pass through an irrelevant region on the game interface. The irrelevant region is any region except the sensing region of the first control and the view adjustment region on the game interface.

In some aspects, in a case that the terminal device simultaneously detects the continuous touch operation and the slide operation from the view adjustment region to the first control, the terminal device displays the first control as the first wheel. In some aspects, the continuous touch operation is performed prior to the slide operation from the view adjustment region to the first control, or the slide operation from the view adjustment region to the first control is performed prior to the continuous touch operation, or the continuous touch operation and the slide operation from the view adjustment region to the first control are synchronously performed.

In an example, if the terminal device detects the slide operation from the view adjustment region to the first control, and the continuous touch operation always exists in a holding process of the slide operation, after the slide operation reaches the first control, the terminal device displays the first control as the first wheel.

In another example, after detecting the continuous touch operation within the view adjustment region, the terminal device detects whether the slide operation starting from the view adjustment region exists. If the slide operation starting from the view adjustment region exists, the terminal device uses a skill control at which a slide end point of the slide operation is located as the first control, uses a contact point corresponding to the slide operation as a contact point corresponding to the first trigger operation, and adjusts the view direction of the virtual character based on the first trigger operation on the first control. In some aspects, in the process of performing the first trigger operation, the continuous touch operation within the view adjustment region is still continued. The terminal device detects that the continuous touch operation disappears, determines that the switching condition is satisfied, and switches the function of the first control to adjusting the release direction of the directional skill. The terminal device adjusts the release direction of the directional skill in response to the second trigger operation on the first control. By the continuous touch operation within the view adjustment region and the slide operation from the view adjustment region to the first control, the view adjustment function of the skill control is activated without introducing extra controls. Meanwhile, the view adjustment function is activated cooperatively through the continuous touch operation and the slide operation, which helps to reduce a situation in which the view adjustment function of the skill control is incorrectly activated due to false touch or another operation (such as the slide operation only) and helps to reduce an unnecessary computing amount of the terminal device.

In some aspects, the continuous touch operation is triggered by a first finger. The slide operation is triggered by a second finger. The first finger and the second finger are two different fingers.

In some aspects, the continuous touch operation and the slide operation are two operations that are independent of each other. For example, the contact point corresponding to the continuous touch operation is different from the contact point corresponding to the slide operation. The continuous touch operation and the slide operation are supported to be completed by two different fingers. The contact point corresponding to the continuous touch operation moves or is stationary within the view adjustment region, and the contact point corresponding to the slide operation moves from the view adjustment region to the sensing region of the first control.

In some aspects, the first finger and the second finger are from the same hand part or different hand parts. In some aspects, the first finger and the second finger are from the same hand part. For example, the first finger is from the left hand, and the second finger is from the right hand. For example, the first finger is the index finger of the left hand, and the second finger is the index finger of the right hand. In an actual game process, the first finger and the second finger are determined based on a use habit of a user. The continuous touch operation and the slide operation from the view adjustment region to the first control are respectively completed with any two fingers. Types of the first finger and the second finger are not limited in this disclosure.

In an example, the continuous touch operation is triggered by a finger of the left hand, and the slide operation is triggered by a finger of the right hand. The index finger of the left hand of the user remains stationary within the view adjustment region, and a finger of the left hand moves from the view adjustment region to the first control, to complete activation of the view adjustment function of the first control. In this process, the terminal device detects the slide operation from the view adjustment region to the first control and can always detect the continuous touch operation within the view adjustment region in a holding process of the slide operation. After detecting that the slide operation reaches the first control, the terminal device displays the first control as the first wheel. For example, the terminal device switches to display a gray first control as a yellow first wheel.

By setting the slide operation and the continuous touch operation to be completed by different fingers, it helps to improve a possibility of synchronously keeping the slide operation and the continuous touch operation, helps to successfully activate the view adjustment function of the skill control through one operation, and reduces adverse effects on the user in the game because the view adjustment function of the skill control cannot be successfully activated due to an operation error.

The switching condition is described below through several aspects.

In some aspects, the switching condition includes: it is detected that the continuous touch operation within the view adjustment region disappears.

In a case that the continuous touch operation has been detected within the view adjustment region, as shown in FIG. 13, operation 230 may be implemented as: sub-operation 232: in a case that it is detected that the continuous touch operation within the view adjustment region disappears, adjust the release direction of the directional skill of the virtual character in response to the second trigger operation on the first control. For example, the switch condition is satisfied when a continuous touch operation within a view adjustment region ends.

In some aspects, the first trigger operation and the continuous touch operation within the view adjustment region synchronously occur. After the continuous touch operation within the view adjustment region disappears, the function of the first control is switched to adjusting the release direction of the directional skill. For example, the view adjustment function of the first control is continuously activated through the continuous touch operation within the view adjustment region. After the continuous touch operation within the view adjustment region disappears, the view adjustment function of the first control is lost.

In some aspects, disappearance of the continuous touch operation within the view adjustment region refers to disappearance of the contact point corresponding to the continuous touch operation, that is, the terminal device senses that the contact point corresponding to the continuous touch operation disappears.

In some aspects, in a case that the continuous touch operation within the view adjustment region disappears, that the terminal device switches to display the first control, which is displayed as the first wheel, as the second wheel includes: canceling displaying the first wheel, and displaying the second wheel in the display region of the first wheel; or, keeping displaying the first wheel, and displaying the second wheel in the display region of the first wheel. For example, the second wheel covers the first wheel.

For example, assuming that the continuous touch operation within the view adjustment region is a touch and hold operation performed within the view adjustment region with the left hand, the terminal device switches to display the first wheel as the second wheel in response to an end of the touch and hold operation.

In conclusion, based on whether the continuous touch operation within the view adjustment region disappears, the method provided in this aspect determines a function switching occasion of the skill control, so that the function switching occasion is controllable by a user, and the user can continuously complete the operation of releasing the directional skill of the virtual character on the game interface. Therefore, the user does not need to adjust the view direction of the virtual character and the release direction of the directional skill of the virtual character respectively, which is conducive to improving an operation experience of the user to an extent.

In some aspects, after operation 210, the aiming method in the virtual environment further includes: operation 217 (not shown in the figure): display an auxiliary display element, the auxiliary display element being configured for prompting a relative orientation between a release target of the directional skill and the virtual character.

In some aspects, the auxiliary display element is configured for assisting a user to correctly adjust the view direction of the virtual character. For example, the user adjusts the view direction of the virtual character through the first trigger operation on the first control with reference to the auxiliary display element, so that the release target of the directional skill is within a field of view range of the virtual character.

In some aspects, the release target of the directional skill includes at least one of the following: an enemy virtual character, a friend virtual character, a virtual prop in the virtual environment, or a virtual item in the virtual environment. The release target of the directional skill may be understood as an object on which the directional skill takes effect.

In some aspects, the release target of the directional skill is related to a skill effect of the directional skill. For example, in a case that the directional skill is a hook lock skill, the release target of the directional skill is an enemy virtual character. For example, in a case that the directional skill is a support skill, the release target of the directional skill is a friend virtual character. For example, the friend virtual character is guided, through the support skill, to leave a dangerous region (for example, a region that damages a hit point or another game attribute of the friend virtual character) in the game. For example, in a case that the directional skill is a pick skill, the release target of the directional skill is a virtual prop or a virtual item. For example, in a case that the directional skill hits a first virtual prop, a total quantity of first virtual props owned by the virtual character is plus one, and the first virtual prop disappears from the virtual environment.

In some aspects, the auxiliary display element is displayed on the game interface after the release target appears in a perception region of the virtual character.

A function of the auxiliary display element is described below by using an example in which the release target of the directional skill is the enemy virtual character. When the release target of the directional skill is different, the function of the auxiliary display element is basically the same. For example details, reference can be made to the following examples, which will not be elaborated.

In some aspects, in a case that the release target of the directional skill is the enemy virtual character, the auxiliary display element is also referred to as an enemy display element. For example, a hiding region (such as grass or a building) that can hide a figure of the enemy virtual character is configured in the virtual environment, a sound may be made when the enemy virtual character moves in the hiding region, and the enemy display element is configured for displaying a sound source. In this case, the enemy display element is also referred to as voiceprint information, a sound element, and an enemy voiceprint, and is configured for representing a relative orientation between the sound source generated by the movement of the enemy virtual character and the virtual character controlled by the first user, so as to prompt a relative orientation of the enemy virtual character in the hiding region.

In some aspects, the enemy virtual character is another virtual character in the virtual environment except the virtual character 1 controlled by the first user. In some aspects, the another virtual character is controlled by another user except the first user. For example, the enemy virtual character is the virtual character 2 controlled by the second user. The enemy display element is a display element for representing the enemy virtual character, for example, a sound element.

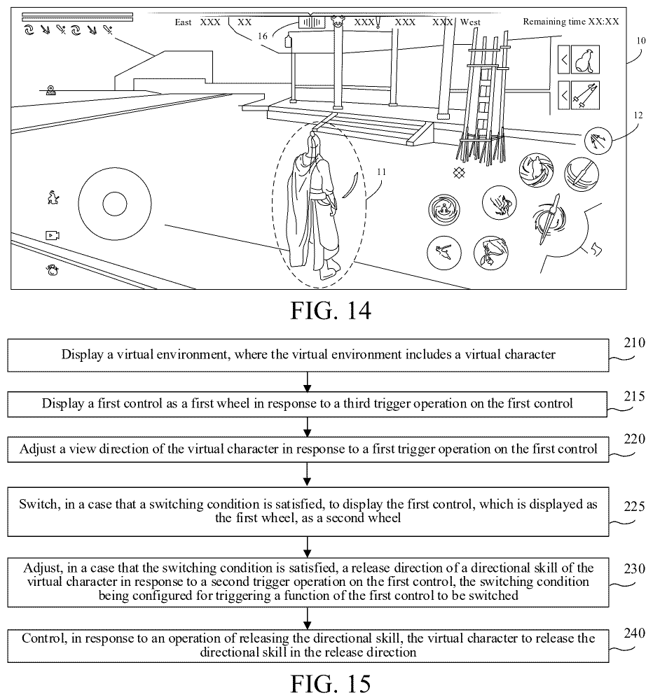

For example, as shown in FIG. 14, an enemy voiceprint 16 is displayed on the game interface 10. The terminal device adjusts the view direction of the virtual character in response to the first trigger operation on the first control, so that the view direction of the virtual character is gradually aligned with the enemy voiceprint 16. After a user determines that the view direction of the virtual character is aligned with the enemy voiceprint 16, the switching condition is triggered through a user operation (such as canceling the continuous touch operation within the view adjustment region). The terminal device determines that the switching condition is currently satisfied, and switches to display the first wheel as the second wheel.

In some aspects, the view direction of the virtual character is adjusted in response to the first drag operation on the first wheel, so that the view direction of the virtual character faces the enemy display element. In some aspects, a view center identifier is displayed on the game interface. The view center identifier is configured for representing the view direction of the virtual character. For example, the field of view range of the virtual character is a fan-shaped region using the view direction as an axis. The view center identifier is configured for indicating an orientation of the view direction of the virtual character in the virtual environment.

In a case that the enemy display element overlaps the view center identifier, the user may determine that the view direction of the virtual character faces the enemy display element. In this case, the enemy virtual character is located at a view center of the virtual character, which facilitates the released directional skill to hit the enemy virtual character.

FIG. 15 is a flowchart of an aiming method in a virtual environment according to an aspect of this disclosure. An example in which the method is performed by the terminal device 110 shown in FIG. 1 is used. The method mainly includes the following several operations.

Operation 210: Display a virtual environment, the virtual environment including a virtual character.

Operation 215: Display a first control as a first wheel in response to a third trigger operation on the first control.

In this aspect, the first control has various display styles in a game process. When functions of the first control are different, the display styles of the first control are different. In a case that the terminal device receives the third trigger operation on the first control, the terminal device switches an original display style of the first control to a display style of the first wheel. The original display style of the first control and the display style of the first wheel are different in at least one aspect such as a color, a shape, or a size.

In some aspects, the third trigger operation is implemented as a slide operation from a view adjustment region to the first control. For example, after the terminal device receives the slide operation from the view adjustment region to the first control, the terminal device activates a view adjustment function of the first control. To reduce ineffective activation of the view adjustment function of the first control caused by an error, for example, in a case that the third trigger operation and a continuous touch operation within the view adjustment region have been detected, the terminal device displays the first control as the first wheel. If only the third trigger operation has been detected, or only the continuous touch operation within the view adjustment region has been detected, the terminal device does not display the first control as the first wheel.

Operation 220: Adjust a view direction of the virtual character in response to a first trigger operation on the first control.

In some aspects, the first trigger operation is a slide operation on the first control. For example, the first trigger operation and the third trigger operation belong to continuous operations. For example, if the third trigger operation is the slide operation from the view adjustment region to the first control, a finger implements the slide operation. After a contact point corresponding to the slide operation reaches the first control, the finger does not leave a screen of the terminal device, and a subsequent operation of the finger belongs to the first trigger operation.

Operation 225: Switch, in a case that a switching condition is satisfied, to display the first control, which is displayed as the first wheel, as a second wheel. For example, when the switching condition is satisfied, the first control element is switched to be output for display as a second wheel. The first wheel and the second wheel have different display styles.

In some aspects, the switching condition is that the continuous touch operation within the view adjustment region disappears. Before the switching condition is satisfied, a function of the first control is to adjust the view direction of the virtual character. After the switching condition is satisfied, a function of the first control is to adjust a release direction of a directional skill. To help a user to distinguish whether the function of the first control is switched, the terminal device switches to display the first wheel as the second wheel in a case that the switching condition is satisfied, thereby improving visibility of a function switching process.

Operation 230: Adjust, in a case that the switching condition is satisfied, a release direction of a directional skill of the virtual character in response to a second trigger operation on the first control, the switching condition being configured for triggering a function of the first control to be switched.

Execution time sequences of operation 225 and operation 230 are not in a particular order. Operation 225 may be performed prior to operation 230, or may be performed after operation 230. Or, operation 225 and operation 230 may be synchronously performed.

Operation 240: Control, in response to an operation of releasing the directional skill, the virtual character to release the directional skill in the release direction.

For specific content of this aspect, reference can be made to the above aspects. Details will not be described here again.

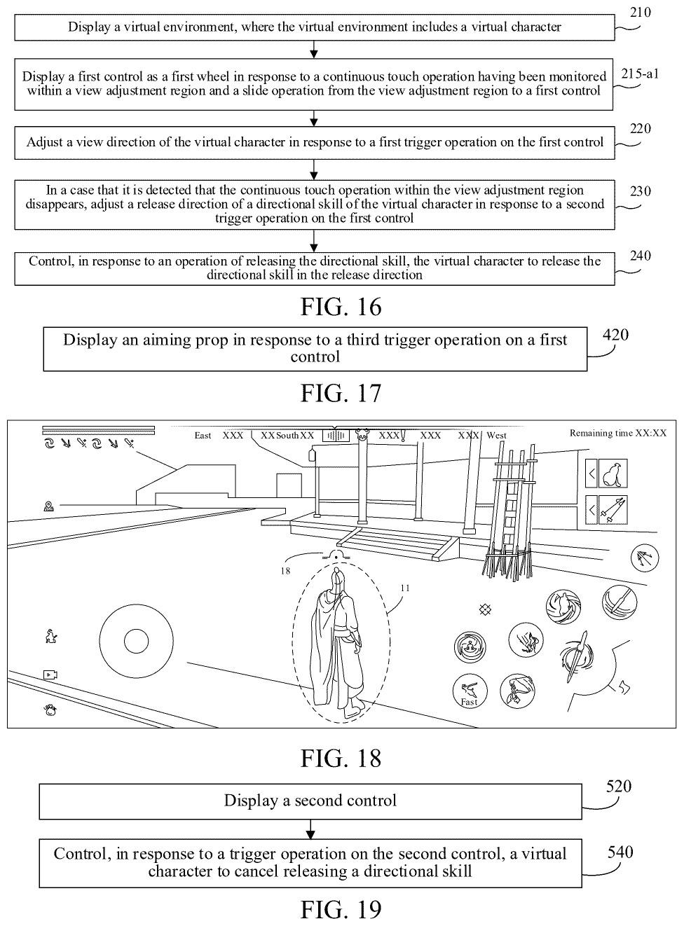

In some aspects, the switching condition is related to the continuous touch operation within the view adjustment region. As shown in FIG. 16, operation 215 may be implemented as sub-operation 215-a1: display the first control as the first wheel in response to the continuous touch operation having been monitored within the view adjustment region and the slide operation from the view adjustment region to the first control. For example, the first control element is output for display as the first wheel based on a continuous touch operation within the view adjustment region and the sliding operation performed from the view adjustment region to the first control element.

In this case, operation 230 may be implemented as: sub-operation 232: in a case that it is detected that the continuous touch operation within the view adjustment region disappears, adjust the release direction of the directional skill of the virtual character in response to the second trigger operation on the first control.

In some aspects, the view adjustment region is a fixed region on a game interface. To reduce overlapping with sensing regions of other controls, the view adjustment region is arranged in a center region of the game interface.

In some aspects, the view adjustment region does not have a display identifier on the game interface. A user determines a position of the view adjustment region based on a game experience. In some aspects, the view adjustment region has a display identifier on the game interface, such as a highlighted trace displayed at an edge of the view adjustment region.

In some aspects, before a game starts, the terminal device determines a position and display size of the view adjustment region on the game interface in response to a region indication operation. In some aspects, the terminal device displays a region display interface. The region display interface is configured for presenting a layout of controls on the game interface and a position of another game display element (such as a store identifier, a chat box, or an attribute bar of the virtual character) on the game interface after a game battle starts. The terminal device determines the position of the view adjustment region on the game interface in response to an operation of placing the view adjustment region; and stores, in response to a confirmation operation on the layout of the view adjustment region, the position of the view adjustment region on the game interface in a case that the view adjustment region does not overlap another control.

For examples of the above operations, reference can be made to the above aspects. Details will not be described here again.

In conclusion, the method provided in this aspect of this disclosure displays the first control as the first wheel in response to the continuous touch operation having been detected within the view adjustment region and the slide operation from the view adjustment region to the first control, so that the terminal device can trigger, based on the continuous touch operation monitored within the view adjustment region, the operation of adjusting the view direction of the virtual character. By this setting, the operation of adjusting the release direction of the virtual character and the operation of adjusting the release direction of the directional skill are combined into a complete consecutive operation, which helps to improve efficiency of releasing the directional skill.

FIG. 17 is a flowchart of an aiming method in a virtual environment according to an aspect of this disclosure. An example in which the method is performed by the terminal device 110 shown in FIG. 1 is used. The method further includes the following operations:

Operation 420: Display an aiming prop in response to the third trigger operation on the first control. For example, an aiming indicator is output for display based on the third trigger operation performed on the first control element. The aiming indicator indicates an aiming position of the virtual character.

In some aspects, the aiming prop is configured for indicating an orientation of a virtual object and/or a release direction of a directional skill of a virtual character. In some aspects, the aiming prop is also referred to as an aiming identifier, a sight, an aiming indicator, or the like. For example, the aiming prop is an identifier displayed on a game interface.

The aiming prop changes based on rotation of the first wheel or the second wheel. For example, when the first wheel rotates clockwise, the aiming prop instructs, by changing clockwise, the orientation of the virtual object to move clockwise.

In some aspects, the aiming prop is configured for indicating an aiming direction of the virtual object. In some aspects, the aiming prop is configured for indicating the release direction of the directional skill of the virtual character.

In some aspects, in a case that the aiming prop is configured for indicating the orientation of the virtual object and the release direction of the directional skill of the virtual character, the aiming prop includes a first aiming sub-prop for indicating the orientation of the virtual object and a second sub-prop for indicating the release direction of the directional skill of the virtual character.

In some aspects, the aiming prop is displayed in any region that does not affect a game display element on the game interface. The game display element includes at least one of a virtual character, a virtual prop, and a control. For example, the aiming prop is displayed in a blank region on the game interface, or is displayed in a region that does not affect a response of another control on the game interface.

In some aspects, the aiming prop is displayed in a fixed region on the game interface. For example, as shown in FIG. 18, an aiming prop 18 is displayed above the virtual character 11.

In some aspects, a display position of the aiming prop is fixed. In some aspects, a display position of the aiming prop is adjusted based on a movement position of the virtual character.

Operation 215 and operation 420 are simultaneously performed. For example, in response to the third trigger operation on the first control, the first control is displayed as the first wheel and the aiming prop is displayed.

In conclusion, in the method provided in this aspect of this disclosure, by displaying the aiming prop, when the view direction of the virtual character and/or the release direction of the directional skill of the virtual character are/is adjusted, a user can be helped to more accurately aim at a release target of the directional skill through the aiming prop.

FIG. 19 is a flowchart of an aiming method in a virtual environment according to an aspect of this disclosure. An example in which the method is performed by the terminal device 110 shown in FIG. 1 is used. The method further includes the following operations:

Operation 520: Display a second control. For example, a second control element is output for display.

In some aspects, the second control is displayed on the game interface. The second control is configured for canceling releasing the directional skill.

In some aspects, before the directional skill of the virtual character is released in a target direction, the terminal device displays the first control on the game interface. For example, before the terminal device receives the operation of releasing the directional skill, the second control is displayed on the game interface. For example, in a preparing process of releasing the directional skill, a user terminates, through the second control, the preparing process (including adjusting the view direction of the virtual character and adjusting the release direction of the directional skill) of releasing the directional skill.

In some aspects, after the directional skill is released, the terminal device displays a release cancellation control on the game interface. For example, operation 520 may be performed prior to or after operation 240. For example, after the directional skill has been released into the virtual environment, the user terminates the releasing process of the directional skill in advance through the second control.

In some aspects, a display position of the second control on the game interface does not overlap another game display element on the game interface, so that displaying the second control less blocks the another game display element, or does not block the another game display element. The game display element includes at least one of a virtual character, a virtual prop, and a control. For example, the second control is displayed in a blank region on the game interface, or is displayed in a region that does not overlap another control on the game interface.

In some aspects, the second control is displayed in a fixed region on the game interface. For example, the first control and the second control are displayed on the same fixed region. The fixed region is a region that has a stable position, a fixed form, and a fixed size on the game interface. The fixed region is set in advance.

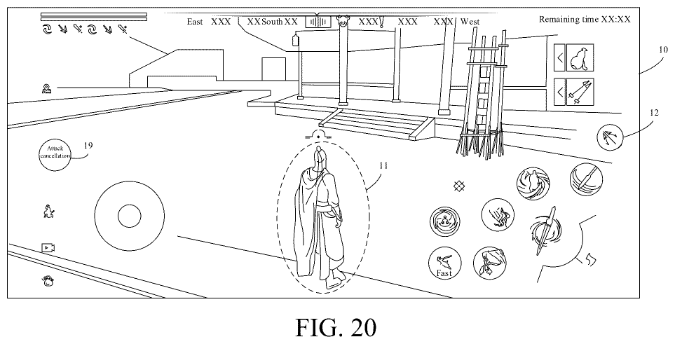

In some aspects, on the game interface, the display position of the second control is adjacent to the display position of the first control. For example, a distance between a center position of the first control and a center position of the second control is less than or equal to x pixels, x being a positive integer. For example, x is equal to 30. For example, the second control is displayed around the first control, to facilitate a user to perform a trigger operation on the second control in time when releasing the directional skill needs to be canceled. For example, as shown in FIG. 20, the directional skill control 12 is displayed on the right hand side of the game interface 10, and a release cancellation control 19 is displayed at a position, which corresponds to the directional skill control 12, on the left hand side of the game interface 10.

In some aspects, the display position of the second control is fixed. In some aspects, the display position of the second control is randomly adjustable.

In some aspects, to reduce the blocking caused by the second control on the another game display element, a size of the second control is smaller than or equal to a size of the first control, which reduces a position occupied by the displaying of the second control. In some aspects, a shape of the second control includes, but is not limited to, a square, a circle, and the like. In some aspects, a color of the second control is consistent with a color of the first control, so as to visualize an association relationship between the function of the first control and the function of the second control, so that a user can quickly find out the second control from the game interface based on the color of the first control.

Operation 540: Control, in response to a trigger operation on the second control, the virtual character to cancel releasing the directional skill. For example, based on a third trigger operation performed on the second control element, the virtual character is controlled to cancel releasing of the directional skill.

In some aspects, the trigger operation on the second control includes at least one of single click/tap, double click/tap, slide left and right, slide up and down, touch and hold, hover, face recognition, and voice recognition. The trigger operation on the second control includes, but is not limited to, the above several types, and is not limited here in this disclosure.

In some aspects, the controlling the virtual character to cancel releasing the directional skill includes at least one of the following: 1. Cancel releasing the directional skill before the directional skill is released. 2. Cancel a lasting effect of the directional skill after the directional skill has been released. For example, effect-taking duration of the directional skill is 5 s. At the 2nd s after the directional skill is released, if the directional skill is canceled being released, the terminal device immediately zeros the effect-taking duration of the directional skill and cancels displaying a release effect of the directional skill.

In some aspects, in a case that operation 520 is performed prior to operation 240, an execution time sequence of operation 540 is before or after operation 240. In an example, before the directional skill is released, the terminal device displays the second control on the game interface. Before the directional skill is released, the terminal device controls, in response to the trigger operation on the release cancellation control, the virtual character to cancel releasing the directional skill. In another example, before the directional skill is released, the terminal device displays the second control on the game interface. After the directional skill is released, the terminal device controls, in response to the trigger operation on the second control, the virtual character to cancel releasing the directional skill.

In conclusion, the method provided in this aspect supports a user to cancel releasing the directional skill through the second control. In the game process, the release target of the directional skill has a movement ability. Even if the directional skill aims at the release target at a moment, when the release target moves at the moment, the directional skill cannot hit the release target. In this case, the directional skill is canceled being released through the second control, which helps to withdraw the directional skill in time, to shorten cooling duration of the directional skill and improve flexibility of releasing the directional skill.

In this aspect of this disclosure, operation 215, operation 215a, operation 215-a1, operation 225, operation 420, operation 520, and operation 540 are selectable. In different aspects, one or more of these operations may be omitted or replaced.

Operation 210, operation 220, operation 230, and operation 240 may be implemented as an independent aspect. Operation 210, operation 215, operation 230, and operation 240 may be implemented as an independent aspect. Operation 210, operation 220, operation 232, and operation 240 may be implemented as an independent aspect. Operation 210, operation 225, operation 230, and operation 240 may be implemented as an independent aspect. Operation 210, operation 215, operation 220, operation 230, and operation 240 may be implemented as an independent aspect. Operation 210, operation 215, operation 220, operation 232, and operation 240 may be implemented as an independent aspect. Operation 210, operation 215-a1, operation 220, operation 230, and operation 240 may be implemented as an independent aspect. Operation 210, operation 215-a1, and operation 232 may be implemented as an independent aspect. Operation 420 may be implemented as an independent aspect. Operation 520 and operation 540 may be implemented as an independent aspect. Every two or more of the above method aspects may be combined based on an understanding of a person skilled in the art, to form more aspects. Details will not be described in this disclosure.

In some aspects, a related operating mode for aiming in the virtual environment is defined in advance in an application program that supports releasing the directional skill of the virtual character in the virtual environment. In some aspects, the operating mode includes:
an ordinary mode;
a view rotation mode, i.e. a front mode (hereinafter referred to as a preparing mode) in which the operation of adjusting the view direction of the virtual character and the operation of adjusting the release direction of the directional skill of the virtual character are combined into one complete consecutive operation;
an associated view mode, i.e. a mode of adjusting the view direction of the virtual character; and
an associated skill mode, i.e. a mode of adjusting the release direction of the directional skill of the virtual character.

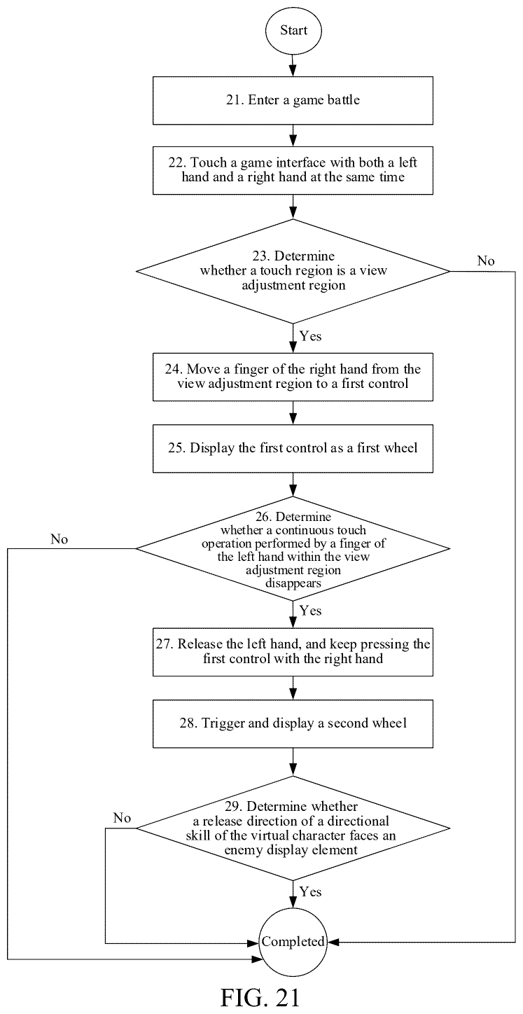

In some aspects, as shown in FIG. 21, in the above four operating modes, the method includes:

Operation 21: Enter a game battle.

In some aspects, a first user opens a game program and enters the ordinary mode in the game battle. The game battle includes a virtual character 1 controlled by the first user and another virtual character controlled by another user.

Operation 22: Press a game interface with both the left hand and the right hand at the same time.

In some aspects, whether a mode switching condition of switching an operating mode from the ordinary mode to the view rotation mode is satisfied is monitored. In some aspects, whether a target region is pressed is monitored.

In some aspects, whether a left target region of the game interface is pressed and whether a right target region of the game interface is pressed are monitored. In a case that it is monitored that the left target region of the game interface is pressed and it is monitored that the right target region of the game interface is pressed, the operating mode is switched from the ordinary mode to the view rotation mode.

Operation 23: Determine whether a view adjustment region is pressed.

In some aspects, the operating mode is re-switched from the view rotation mode to the ordinary mode in a case that the view adjustment region is not pressed simultaneously with the left hand and the right hand.

In some aspects, the following operations are continued to be performed in a case that the view adjustment region is not pressed simultaneously with the left hand and the right hand.

Operation 24: Move the right hand from the view adjustment region to a directional skill control.

In some aspects, the operating mode is switched from the view rotation mode to the associated view mode in a case that the right hand is moved from the view adjustment region to the directional skill control.

Operation 25: Trigger and display a first wheel.

In some aspects, in a case that the right hand is moved from the view adjustment region to the directional skill control, the operating mode is switched from the view rotation mode to the associated view mode, and the first wheel is triggered and displayed.

Operation 26: Determine, whether a view direction of the virtual character faces an enemy display element.

In some aspects, in a case that the view direction of the virtual character does not face the enemy display element, the first wheel continues to be used to adjust the view direction of the virtual character until the view direction of the virtual character is adjusted to face the enemy display element; or, the adjustment of the view direction of the virtual character is abandoned, and the operating mode is switched from the associated view mode to the ordinary mode.

In some aspects, in a case that the view direction of the virtual character faces the enemy display element, the following operations continue to be performed.

Operation 27: Release the left hand, and keep pressing the directional skill control with the right hand.

In some aspects, the operating mode is switched from the associated view mode to the associated skill mode in a case that the left hand is released and the directional skill control is kept being pressed with the right hand.

Operation 28: Trigger and display a second wheel.

In some aspects, in a case that the left hand is released and the directional skill control is kept being pressed with the right hand, the operating mode is switched from the associated view mode to the associated skill mode, and the second wheel is triggered and displayed.

Operation 29: Determine, whether a release direction of a directional skill of the virtual character faces the enemy display element.

In some aspects, in a case that the release direction of the directional skill of the virtual character does not face the enemy display element, the second wheel continues to be used to adjust the release direction of the directional skill of the virtual character until the release direction of the directional skill of the virtual character is adjusted to face the enemy display element; or, the adjustment of the release direction of the directional skill of the virtual character is abandoned, and the operating mode is switched from the associated skill mode to the ordinary mode.

In some aspects, the directional skill of the virtual character is released in a case that the release direction of the directional skill of the virtual character faces the enemy display element. In some aspects, the directional skill of the virtual character includes at least one of an aiming skill, a grabbing skill, or a hook lock skill.

The following describes apparatus aspects of this disclosure, which can be configured to perform the method aspects of this disclosure. For examples of details not disclosed in the apparatus aspects of this disclosure, reference can be made to the method aspects of this disclosure.

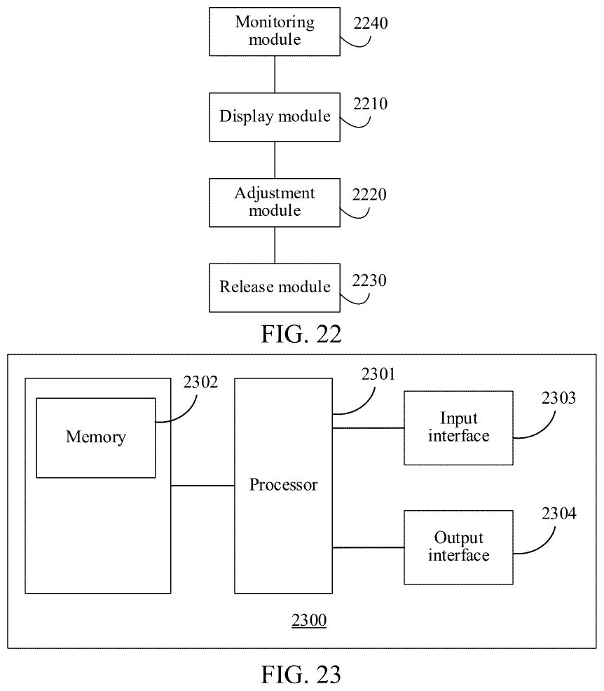

FIG. 22 is a block diagram of an aiming apparatus in a virtual environment according to an aspect of this disclosure. The apparatus at least includes the following several modules: a display module 2210, an adjustment module 2220, and a release module 2230.

The display module 2210 is configured to display a virtual environment, the virtual environment including a virtual character.

The adjustment module 2220 is configured to adjust a view direction of the virtual character in response to a first trigger operation on a first control.

The adjustment module 2220 is further configured to: adjust, in a case that a switching condition is satisfied, a release direction of a directional skill of the virtual character in response to a second trigger operation on the first control, the switching condition being configured for triggering a function of the first control to be switched.

The release module 2230 is configured to control, in response to an operation of releasing the directional skill, the virtual character to release the directional skill in the release direction.

In some aspects, the display module 2210 is further configured to switch, in a case that the switching condition is satisfied, to display the first control, which is displayed as a first wheel, as a second wheel, the first wheel and the second wheel having different display styles.

In some aspects, each display style includes at least one of the following: a color, a size, and a shape.

In some aspects, the apparatus further includes a monitoring module 2240, configured to display the first control as the first wheel in response to a slide operation from a view adjustment region to the first control.

In some aspects, the apparatus further includes a monitoring module 2240, further configured to display the first control as the first wheel in response to a continuous touch operation having been monitored within the view adjustment region and the slide operation from the view adjustment region to the first control.

In some aspects, the continuous touch operation is triggered by a first finger. The slide operation is triggered by a second finger. The first finger and the second finger are two different fingers.

In some aspects, the display module 2210 is further configured to display an aiming prop in response to a third trigger operation on a first control, the aiming prop being configured for indicating an aiming position of the virtual character.

In some aspects, the switching condition includes: it is detected that the continuous touch operation within the view adjustment region disappears.

In some aspects, the display module 2210 is further configured to display an auxiliary display element, the auxiliary display element being configured for prompting a relative orientation between a release target of the directional skill and the virtual character.

When the apparatus provided in the foregoing aspects implements functions of the apparatus, the division of the foregoing functional modules is merely an example for description. In the practical application, the functions may be assigned to and completed by different functional modules according to the requirements. For example, the internal structure of the device is divided into different functional modules, to implement all or some of the functions described above. In addition, the apparatus provided in the foregoing aspects and the method aspects belong to the same concept. For example of details of a specific implementation process, reference can be made to the method aspects. Details are not described herein again.

FIG. 23 is a structural block diagram of a computer device 2300 according to an aspect of this disclosure.

The computer device 2300 includes a processor 2301 (an example of processing circuitry) and a memory 2302 (an example of non-transitory computer-readable storage medium).

The processor 2301 may include one or more processing cores, for example, a 4-core processor or an 8-core processor. The processor 2301 may be implemented by using at least one hardware form of a digital signal processing (DSP), a field-programmable gate array (FPGA), and a programmable logic array (PLA). The processor 2301 may further include a main processor and a coprocessor. The main processor is a processor configured to process data in an awake state, and is also referred to as a central processing unit (CPU). The coprocessor is a low-power processor configured to process data in a standby state. In some aspects, the processor 2301 may be integrated with a graphics processing unit (GPU). The GPU is configured to render and draw content that needs to be displayed on a display screen. In some aspects, the processor 2301 may further include an artificial intelligence (AI) processor. The AI processor is configured to process computing operations related to machine learning.

The memory 2302 may include one or more computer-readable storage media. The computer-readable storage media may be non-transitory. The memory 2302 may further include a high-speed random access memory and a nonvolatile memory, for example, one or more disk storage devices or flash storage devices.

In some aspects, the non-transitory computer-readable storage media in the memory 2302 are configured to store at least one computer instruction. The at least one computer instruction is configured for being executed by the processor 2301 to implement the aiming method in the virtual environment provided in the method aspects of this disclosure.

In some aspects, the computer device 2300 may further include: an input interface 2303 and an output interface 2304. The processor 2301, the memory 2302, the input interface 2303, and the output interface 2304 may be connected through a bus or a signal wire. Each peripheral may be connected to the input interface 2303 and the output interface 2304 through a bus, a signal wire, or a circuit board. The input interface 2303 and the output interface 2304 may be configured for connecting at least one peripheral related to input/output (I/O) to the processor 2301 and the memory 2302.

In some aspects, the processor 2301, the memory 2302, the input interface 2303, and the output interface 2304 are integrated on the same chip or circuit board. In some other aspects, any one or two of the processor 2301, the memory 2302, the input interface 2303, and the output interface 2304 may be implemented on an independent chip or circuit board. This is not limited in this aspect of this disclosure. A person skilled in the art may understand that the foregoing structures do not constitute a limitation on the computer device 2300, and the computer device 2300 may include more components or fewer components than those shown in the figure, or some components may be combined, or a different component deployment may be used.

In an aspect, a computer-readable storage medium, such as a non-transitory computer-readable storage medium, is further provided, having at least one segment of computer instruction stored therein. The at least one segment of computer instruction is configured for implementing the above aiming method in the virtual environment when executed by a processor. In some aspects, the computer-readable storage medium may be a read-only memory (ROM), a random access memory (RAM), a compact disc read-only memory (CD-ROM), a magnetic tape, a floppy disk, an optical data storage device, or the like.

In an aspect, a computer program product is further provided. The computer program product includes a computer instruction. The computer instruction is stored in a computer-readable storage medium, and a processor reads the computer instruction from the computer-readable storage medium and executes the computer instruction, to implement the above aiming method in the virtual environment.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

“Plurality of” mentioned herein means two or more. The term “and/or” describes an association relationship of associated objects, representing that three relationships may exist. For example, A and/or B may represent three situations: A exists alone; A and B exist simultaneously; and B exists alone. The character “/” usually indicates an “or” relationship between associated objects.

It is noted that all or some of the steps of the foregoing aspects may be implemented by hardware, or may be implemented by a program instructing relevant hardware. The program may be stored in a computer-readable storage medium. The storage medium mentioned above may be a ROM, a magnetic disk, an optical disc, or the like.

What is claimed is:

1. An aiming method in a virtual environment, the method comprising:
outputting for display the virtual environment including a virtual character;
adjusting a view direction of the virtual character based on a first trigger operation performed on a first control element;
adjusting, when a switching condition is satisfied, a release direction of a directional skill of the virtual character based on a second trigger operation performed on the first control element, the switching condition being configured to trigger a function of the first control element to be switched; and
controlling, based on a release operation to release the directional skill, the virtual character to release the directional skill in the release direction.

2. The method according to claim 1, further comprising:
outputting for display the first control element as a first wheel; and
switching, when the switching condition is satisfied, to output the first control element as a second wheel, the first wheel and the second wheel having different display styles.

3. The method according to claim 2, wherein the different display styles of the first wheel and the second wheel include at least one of: different colors, different sizes, and different shapes.

4. The method according to claim 2, further comprising:
outputting for display the first control element as the first wheel based on a third trigger operation performed on the first control element.

5. The method according to claim 4, wherein the outputting for display the first control element as the first wheel comprises:
outputting for display the first control element as the first wheel based on a sliding operation performed from a view adjustment region to the first control element.

6. The method according to claim 5, wherein the outputting for display the first control element as the first wheel based on to the sliding operation comprises:
outputting for display the first control element as the first wheel based on a continuous touch operation within the view adjustment region and the sliding operation performed from the view adjustment region to the first control element.

7. The method according to claim 6, wherein the continuous touch operation is performed by a first finger, and the sliding operation is performed by a second finger different from the first finger.

8. The method according to claim 4, further comprising:
outputting for display an aiming indicator based on the third trigger operation performed on the first control element, the aiming indicator indicating an aiming position of the virtual character.

9. The method according to claim 1, wherein the switching condition comprises:
detecting that a continuous touch operation within a view adjustment region ends.

10. The method according to claim 1, further comprising:
outputting for display a second control element; and
controlling, based on a third trigger operation performed on the second control element, the virtual character to cancel releasing of the directional skill.

11. The method according to claim 1, further comprising:
outputting for display an auxiliary display indicator indicating a relative orientation between a release target of the directional skill and the virtual character.

12. An information process apparatus, comprising:
processing circuitry configured to:
output for display a virtual environment including a virtual character;
adjust a view direction of the virtual character based on a first trigger operation performed on a first control element;
adjust, when a switching condition is satisfied, a release direction of a directional skill of the virtual character based on a second trigger operation performed on the first control element, the switching condition being configured to trigger a function of the first control element to be switched; and
control, based on a release operation to release the directional skill, the virtual character to release the directional skill in the release direction.

13. The apparatus according to claim 12, wherein the processing circuitry is configured to:
output for display the first control element as a first wheel; and
switch, when the switching condition is satisfied, to output the first control element as a second wheel, the first wheel and the second wheel having different display styles.

14. The apparatus according to claim 13, wherein the different display styles of the first wheel and the second wheel include at least one of: different colors, different sizes, and different shapes.

15. The apparatus according to claim 13, wherein the processing circuitry is configured to:
output for display the first control element as the first wheel based on a third trigger operation performed on the first control element.

16. The apparatus according to claim 15, wherein the processing circuitry is configured to:
output for display the first control element as the first wheel based on a sliding operation performed from a view adjustment region to the first control element.

17. The apparatus according to claim 16, wherein the processing circuitry is configured to:
output for display the first control element as the first wheel based on a continuous touch operation within the view adjustment region and the sliding operation performed from the view adjustment region to the first control element.

18. The apparatus according to claim 17, wherein the continuous touch operation is performed by a first finger, and the sliding operation is performed by a second finger different from the first finger.

19. The apparatus according to claim 15, wherein the processing circuitry is configured to:
output for display an aiming indicator based on the third trigger operation performed on the first control element, the aiming indicator indicating an aiming position of the virtual character.

20. A non-transitory computer-readable storage medium storing instructions which, when executed by a processor, cause the processor to perform:
outputting for display a virtual environment including a virtual character;
adjusting a view direction of the virtual character based on a first trigger operation performed on a first control element;
adjusting, when a switching condition is satisfied, a release direction of a directional skill of the virtual character based on a second trigger operation performed on the first control element, the switching condition being configured to trigger a function of the first control element to be switched; and
controlling, based on a release operation to release the directional skill, the virtual character to release the directional skill in the release direction.
